(19) United States
(12) Patent Application Publication
(10) Pub. No.: US 2025/0324139 A1
(43) Pub. Date: Oct. 16, 2025

(54) INFORMATION PROCESSING METHOD AND APPARATUS, COMPUTER DEVICE, AND COMPUTER-READABLE STORAGE MEDIUM

(71) Applicant: TENCENT TECHNOLOGY (SHENZHEN) COMPANY LIMITED, Shenzhen (CN)

(72) Inventors: Shuyuan LI, Shenzhen (CN); Qingqing REN, Shenzhen (CN); Yunming HUANG, Shenzhen (CN); Chuanyu ZHANG, Shenzhen (CN); Yanhua ZHAO, Shenzhen (CN); Zirui CHENG, Shenzhen (CN); Silin LIU, Shenzhen (CN); Guiyi YANG, Shenzhen (CN); Jinchao ZENG, Shenzhen (CN)

(21) Appl. No.: 19/248,160

(22) Filed: Jun. 24, 2025

Related U.S. Application Data
(63) Continuation of application No. PCT/CN2024/082806, filed on Mar. 20, 2024.

(30) Foreign Application Priority Data
May 18, 2023 (CN) 202310566889.9

(51) Int. Cl. H04N 21/4788; H04N 21/431; H04N 21/472

(52) U.S. Cl. CPC H04N 21/4788; H04N 21/4312; H04N 21/47217

(57) ABSTRACT

An information processing method includes: displaying a video playback interface in a bullet comment display mode; displaying target information in a process of playing a video, and outputting an interaction control related to the target information; and displaying bullet comment interaction content in the video playback interface in response to a trigger operation for the interaction control.

### CROSS-REFERENCES TO RELATED APPLICATIONS

This application is a continuation of PCT Application No. PCT/CN2024/082806, filed on Mar. 20, 2024, which claims priority to Chinese Patent Application No. 202310566889.9 filed on May 18, 2023, the entire contents of all of which are incorporated herein by reference.

### FIELD OF THE TECHNOLOGY

The present disclosure relates to the field of Internet technologies, and in particular, to an information processing method and apparatus, a computer device, a computer-readable storage medium, and a computer program product.

### BACKGROUND OF THE DISCLOSURE

With the development of Internet technologies, add-on content appears in a process of playing a video, and the add-on content is mainly presented in a form of text information, a picture, or the like. However, viewers of the video can only view or directly close the add-on content displayed in the video, which has relatively poor interactivity.

### SUMMARY

Embodiments of the present disclosure provide an information processing method and a related device, to implement interaction with target information and improve interactivity with the target information.

An embodiment of the present disclosure provides an information processing method, including: displaying a video playback interface in a bullet comment display mode; displaying target information in a process of playing a video, and outputting an interaction control related to the target information; and displaying bullet comment interaction content in the video playback interface in response to a trigger operation for the interaction control.

An embodiment of the present disclosure provides an information processing apparatus, including: an interface display module, configured to display a video playback interface including bullet comment information; an information display module, configured to: display target information in a process of playing a video, and output an interaction control related to the target information; and an interaction display unit, configured to display bullet comment interaction content in the video playback interface in response to a trigger operation for the interaction control.

An embodiment of the present disclosure provides a computer device, including: a processor, adapted to execute a computer program; and a non-transitory computer-readable storage medium, the computer-readable storage medium having the computer program stored therein, the computer program, when executed by the processor, implementing the foregoing information processing method.

An embodiment of the present disclosure provides a non-transitory computer-readable storage medium, having a computer program stored therein, and the computer program being loaded by a processor to perform the foregoing information processing method.

In embodiments of the present disclosure, when a video playback interface is in a bullet comment display mode, in a process of playing a video, target information is displayed, and an interaction control related to the target information is output. Bullet comment interaction content is displayed in the video playback interface in response to a trigger operation for the interaction control. In this way, the interaction control related to the target information is set, and interaction with the target information can be implemented by triggering the interaction control. In this way, an add-on content interaction form is expanded. In addition, the bullet comment interaction content triggered and presented by using the interaction control enriches presentation forms of the target information, and implements interaction with the target information, thereby improving interactivity with the target information.

### BRIEF DESCRIPTION OF THE DRAWINGS

FIG. 1a is a schematic structural diagram of an information processing system according to an embodiment of the present disclosure.

FIG. 1b is a schematic diagram of an information processing process according to an embodiment of the present disclosure.

FIG. 2 is a schematic flowchart of an information processing method according to an embodiment of the present disclosure.

FIG. 3a is a schematic diagram of displaying target information according to an embodiment of the present disclosure.

FIG. 3b is a schematic diagram of an target information display manner according to an embodiment of the present disclosure.

FIG. 3c is a schematic diagram of an target information display manner according to an embodiment of the present disclosure.

FIG. 3d is a schematic diagram of outputting an interaction control at a display position of target information according to an embodiment of the present disclosure.

FIG. 4a is a schematic diagram of displaying N pieces of bullet comment interaction content according to an embodiment of the present disclosure.

FIG. 4b is a schematic diagram of displaying N pieces of bullet comment interaction content in an arranged manner according to an embodiment of the present disclosure.

FIG. 4c is a schematic diagram of displaying N pieces of bullet comment interaction content in an arranged manner according to an embodiment of the present disclosure.

FIG. 4d is a schematic diagram of displaying N pieces of bullet comment interaction content in a movement manner according to an embodiment of the present disclosure.

FIG. 4e is a schematic diagram of displaying N pieces of bullet comment interaction content in a movement manner according to an embodiment of the present disclosure.

FIG. 4f displays bullet comment interaction content belonging to different camps in a video playback interface according to an embodiment of the present disclosure.

FIG. 5a is a schematic diagram of displaying bullet comment interaction content belonging to different camps in the same display track in a movement manner according to an embodiment of the present disclosure.

FIG. 5b is a schematic diagram of displaying bullet comment interaction content belonging to different camps in a plurality of display tracks in a movement manner according to an embodiment of the present disclosure.

FIG. 5c is a schematic diagram of displaying bullet comment interaction content belonging to different camps in a video playback interface with movement toward each other according to an embodiment of the present disclosure.

FIG. 5d is a schematic diagram of displaying bullet comment interaction content belonging to different camps in a video playback interface with movement in opposite directions according to an embodiment of the present disclosure.

FIG. 6a is a schematic diagram of presenting a confrontational effect between bullet comment interaction content belonging to different camps in a video playback interface according to an embodiment of the present disclosure.

FIG. 6b is a schematic diagram of presenting an offsetting effect between bullet comment interaction content belonging to different camps in a video playback interface according to an embodiment of the present disclosure.

FIG. 6c is a schematic diagram of presenting a covering effect between bullet comment interaction content belonging to different camps in a video playback interface according to an embodiment of the present disclosure.

FIG. 6d is a schematic diagram of performing confrontational display on bullet comment interaction content belonging to different camps according to an embodiment of the present disclosure.

FIG. 6e is a schematic diagram of performing confrontational display on bullet comment interaction content belonging to different camps according to an embodiment of the present disclosure.

FIG. 7 is a schematic flowchart of an information processing method according to an embodiment of the present disclosure.

FIG. 8 is a schematic structural diagram of an information processing apparatus according to an embodiment of the present disclosure.

FIG. 9 is a schematic structural diagram of a computer device according to an embodiment of the present disclosure.

### DESCRIPTION OF EMBODIMENTS

To make the objectives, technical solutions, and advantages of the present disclosure clearer, the following describes the present disclosure in further detail with reference to the accompanying drawings. The described embodiments are not to be considered as a limitation to the present disclosure. All other embodiments obtained by a person of ordinary skill in the art without creative efforts shall fall within the protection scope of the present disclosure.

In the following description, the term “some embodiments” describes subsets of all possible embodiments, but “some embodiments” may be the same subset or different subsets of all the possible embodiments, and can be concatenated with each other without conflict.

In the following description, the term “first\second” is merely configured for distinguishing between similar objects, and does not represent a specific sorting for the objects. A specific sequence or an order of “first\second” may be interchanged when allowed, so that the embodiments of the present disclosure described herein can be implemented in a sequence other than that shown or described herein.

In the embodiment of the present disclosure, the term “module” or “unit” refers to a computer program with a preset function or a part of the computer program and works, together with other related parts, to implement a preset target, and may be completely or partially implemented by using software, hardware (for example, a processing circuit or a memory) or a combination thereof. Similarly, one processor (or a plurality of processors or memories) may be configured to implement one or more modules or units. In addition, each module or unit may be a part of an overall module or unit including a function of the module or the unit.

Unless otherwise defined, meanings of all technical and scientific terms used in this specification are the same as those usually understood by a person skilled in the art to which the present disclosure belongs. Terms used herein are merely intended to describe the embodiments of the present disclosure, but are not intended to limit the present disclosure.

Before the embodiments of the present disclosure are further described in detail, a description is made on nouns and terms in the embodiments of the present disclosure, and the nouns and terms in the embodiments of the present disclosure are applicable to the following explanations.

### I. Video

The video may be any video. In some embodiments, videos are classified into categories based on content of the videos, and the categories of the videos may include, but are not limited to: funny, gourmet, fashion, travel, entertainment, life, information, games, and the like. In some other embodiments, videos are classified into categories based on presentation forms of the videos. The categories of the videos may include, but are not limited to: a three-dimensional animation video, a video presented by using a virtual reality (VR) technology, or a video presented by using an augmented reality (AR) technology.

In some embodiments, a placement point that can be configured for placing target information (i.e., add-on content) may be provided in the video, and the placement point may include any one of the following: preset scene content in the video and preset playback time of the video. The preset scene content may refer to a specific scene in the video. For example, the preset scene content may include a specific role in the video. For example, the preset scene content may include a role A and a role B that appear in a valley XX. For another example, the preset scene content may include gourmet XX. The preset playback time may be a preset time point of the video content, for example, may be the 5th second or the 10th second in the video.

In some embodiments, the placement point of the target information may be a preconfigured placement point in the video based on a target content add-on requirement (e.g., advertisement requirement). For example, if the target information is information about an umbrella, a scenario in which an umbrella occurs in the video may be set as the placement point of the target information. In some other embodiments, a plurality of placement points may be provisioned in the video, and a demand side (add-on content providers such as an advertiser) may determine the placement point of the target information from the plurality of placement points according to a requirement. “A plurality of” in embodiments of the present disclosure means two or more.

### II. Video Playback Interface

The video playback interface may be configured to play a video, and the video playback interface may be an interface that can play a video in any form. For example, if the video is a three-dimensional animation video, the video playback interface may be an interface for playing the three-dimensional animation video. For another example, if the video is an immersive video, the video playback interface may be an interface for playing the immersive video.

### III. Bullet Comment Information

The bullet comment information is subtitle information that pops up when a video is being viewed. The bullet comment information may include comment information made by an object (such as a video viewer) viewing the video, or may be interaction information related to a currently played video, or may be interaction information unrelated to the currently played video. For example, when the object (that is, the video viewer) views a gourmet video, bullet comment information related to gourmet may be posted on a video playback interface of playing the gourmet video, or bullet comment information unrelated to gourmet may be posted in the video playback interface of playing the gourmet video.

### IV. Target Information

The target information is information that is publicly and widely transmitted for a particular need by using media in a specific form, such as advertisement information. Content forms of the target information are diversified. For example, the target information may be presented in any form that can be perceived by a user, such as a text, an image, an audio, or a video. In embodiments of the present disclosure, the target information may be presented by using a bullet comment in a video in a manner such as a text, an image, or an audio, and the target information may also be referred to as add-on content or bullet comment add-on content.

In some embodiments, the target information may be associated with a video as an add-on content for the video. For example, the target information may include information associated with preset scene content in the video or information associated with video content presented at preset playback time. For example, the preset scene content may include a role A and a role B that appear in a valley XX, and the target information may include a product endorsed by the role A. Alternatively, the target information may be a product endorsed by the role B, or the target information may include products endorsed by the role A and the role B.

### V. Bullet Comment Interaction Content

The bullet comment interaction content refers to information that is in a form of a bullet comment and that is in interaction association with target information in a video playback interface. In some embodiments, the bullet comment interaction content may be associated with target information. For example, the target information includes information about two products (the two products may form two camps), and the bullet comment interaction content may include interaction data associated with the two products. For example, the bullet comment interaction content may include “product A is very good” and “product B is very good”. In some other embodiments, because target information is associated with a video, the bullet comment interaction content may be associated with specific scene content in the video. If the scene content is that an object A and an object B are competing with each other, and target information appears in the scene content, the bullet comment interaction content may include comment information supporting the object A and comment information supporting the object B. In some embodiments, the bullet comment interaction content may be associated with specific scene content and target information in the video. For example, specific scene content is that an object A and an object B are talking about an item corresponding to the target information, and target information appears in the scene content. In this case, the bullet comment interaction content may include comment information supporting feature A of the item, comment information supporting feature B of the item.

Particularly, in embodiments of the present disclosure, if related data of an object, such as comment information transmitted by the object, behavior data generated by the object (such as triggering of an interaction control), and the like are involved, when embodiments of the present disclosure are applied to a specific product or technology, permission or consent of the object needs to be obtained, and collection, use, and processing of the related data all comply with relevant laws and standards of a related country or region.

Embodiments of the present disclosure provide an information processing method and apparatus, a computer device, a computer-readable storage medium, and a computer program product. An interaction control related to target information is set, and interaction with the target information can be implemented by triggering the interaction control. In this way, an add-on content interaction form is expanded. In addition, the bullet comment interaction content triggered and presented by using the interaction control enriches presentation forms of the target information, and implements interaction with the target information, thereby improving interactivity with the target information.

An information processing system provided in embodiments of the present disclosure is described below.

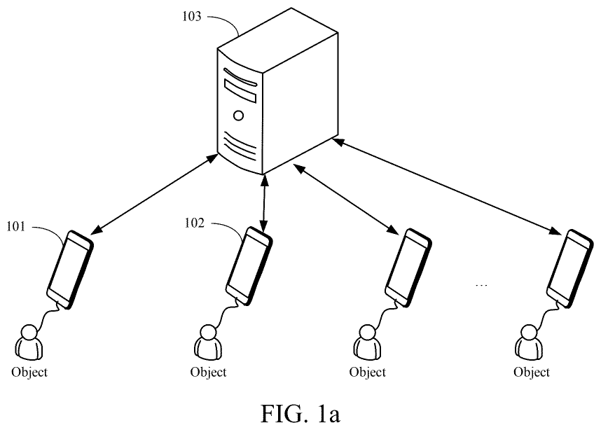

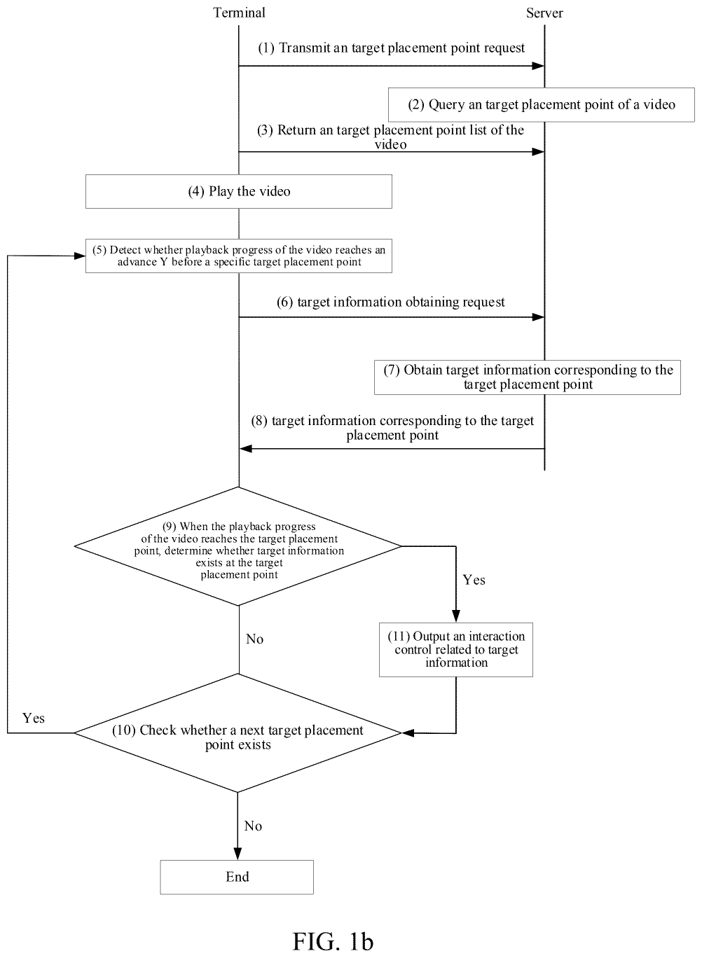

FIG. 1a is a schematic structural diagram of an information processing system according to an embodiment of the present disclosure. As shown in the figure, the information processing system includes a terminal 101, a terminal 102, . . . , and more terminals. A quantity of the terminals is not limited in the present disclosure. The information processing system further includes a server 103. Certainly, there may be a plurality of servers. This is still not limited in the present disclosure. The terminal 101 and the terminal 102 may be understood as terminals used by video viewing objects or terminals used by objects that participate in interaction with target information (referred to as interaction participation objects in the following).

The terminal 101 and the terminal 102 are configured to display a video playback interface, and the terminal 101 and the terminal 102 may be smartphones, tablet computers, notebook computers, desktop computers, intelligent vehicles, intelligent wearable devices, or the like. The server 103 may be an independent physical server, or may be a server cluster or a distributed system formed by a plurality of physical servers, or may be a cloud server that provides basic cloud computing service such as a cloud service, a cloud database, cloud computing, a cloud function, cloud storage, a network service, cloud communication, a middleware service, a domain name service, a security service, a content distribution network (CDN), big data, and an artificial intelligence platform. Any terminal in the information processing system may be directly or indirectly connected to the server 103 in a wired or wireless communication manner, and information may be exchanged between any two terminals by using the server 103.

A detailed description of an interaction process between the terminal and the server shown in FIG. 1a may be provided with reference to FIG. 1b. FIG. 1b is a schematic diagram of an information processing process according to an embodiment of the present disclosure. Referring to FIG. 1b, an information processing procedure between the terminal 101 and the server 103 includes:

(1) After entering a detail page of a video, the terminal 101 transmits a cue point request to the server 103, where the cue point request includes a video identifier (for example, vid) corresponding to the video, and the cue point request is configured for searching for an placement point of the video.

(2) After receiving the cue point request, the server 103 may search storage space thereof for an placement point list of the video, where the placement point list may include one or more placement points. Target information is placed at each of the one or more placement points, or target information is placed at only some of the one or more placement points.

(3) The server 103 returns the placement point list to the terminal 101.

(4) After receiving the placement point list, the terminal 101 starts to play the video in a video playback interface, an object may trigger (for example, tap, double-tap, or slide) a bullet comment display key, the terminal 101 enables a bullet comment display mode in response to a trigger operation for the bullet comment display key, and displays one or more pieces of bullet comment information in the video playback interface in the bullet comment display mode.

(5) The terminal 101 detects whether playback time of the video reaches an advance Y before time corresponding to an placement point, and if the playback time of the video reaches the advance Y before the time corresponding to the placement point, performs operation (6). Y may be set according to a requirement. For example, Y may be set to 2 seconds, 3 seconds, or the like, which is not limited in this embodiment of the present disclosure. For example, the time corresponding to the placement point is playing the video to the 21st minute, and Y is 2 seconds. In this case, when it is detected that the playback time of the video reaches 20^{th} minute 58^{th} second, operation (6) is performed.

(6) The terminal 101 transmits a target content request (e.g., advertisement content request) to the server, where the target content request carries the placement point, and the target content request is configured for requesting target information located at the placement point.

(7) The server 103 queries the target information at the placement point based on the target content request. If the target information at the placement point is not found, prompt information indicating a query failure is returned to the terminal 101. If the target information at the placement point is found successfully, operation (8) is performed.

(8) The server 103 returns the target information at the placement point to the terminal 101.

(9) When detecting that video playback progress reaches the placement point, the terminal may determine whether target information exists at the placement point. If the terminal 101 receives query failure prompt information returned by the server, it may be determined that no target information exists at the placement point, and operation (10) is performed. If the terminal 101 receives the target information at the placement point returned by the server, it may be determined that target information exists at the placement point, and operation (11) is performed.

(10) If target information does not exist at the placement point, the terminal 101 continues to check, based on the placement point list, whether a next placement point exists in the video, and if a next placement point exists, operation (5) to (9) are performed.

(11) If target information exists at the placement point, the terminal 101 may display the target information and output an interaction control related to the target information. For example, “related” herein means that the interaction control may be configured to prompt to participate in interaction with the target information. For example, when output time of the interaction control reaches target time, the interaction control is no longer displayed. In this case, the terminal 101 continues to check, based on the placement point list, whether a next placement point exists in the video.

(12) The object may participate in interaction with the target information based on the interaction control related to the target information. In some embodiments, the object may trigger the interaction control, to participate in interaction with the target information (that is, interact with the target information). In response to the trigger operation for the interaction control, the terminal 101 may allocate one or more pieces of bullet comment interaction content to the object, and display the one or more pieces of bullet comment interaction content in the video playback interface. In some other embodiments, the interaction control may be further configured to prompt to participate in interaction with content confrontation in the target information. The content confrontation may include different camps. An interaction object may trigger the interaction control to select a camp to perform content confrontation (that is, one camp corresponds to one interaction control, and the interaction object selects which interaction control to trigger, that is, selects a camp corresponding to the interaction control). In response to the trigger operation of the interaction control, the terminal 101 may allocate bullet comment interaction content associated with the selected camp to the object, and display bullet comment interaction content belonging to different camps in the video playback interface.

The bullet comment interaction content allocated to the object may be synchronized to the server 103. In this way, when another terminal (such as the terminal 102) plays the video, the bullet comment interaction content allocated to the object is obtained from the server 103, and the bullet comment interaction content allocated to the object is displayed in a video playback interface displayed by the terminal 102. In this embodiment of the present disclosure, an object triggering the interaction control is referred to as an interaction participation object.

In this embodiment of the present disclosure, a video playback interface in a bullet comment display mode is displayed, target information is displayed, and an interaction control related to the target information is output in a process of playing a video. Bullet comment interaction content is displayed in the video playback interface in response to a trigger operation for the interaction control. It can be learned that, in this embodiment of the present disclosure, an interaction control related to target information is set, and interaction with the target information can be implemented by triggering the interaction control. In this way, an add-on content interaction form is expanded. In addition, the bullet comment interaction content triggered and presented by using the interaction control enriches presentation forms of the target information, and implements interaction with the target information, thereby improving interactivity with the target information.

The following describes the information processing method provided in embodiments of the present disclosure.

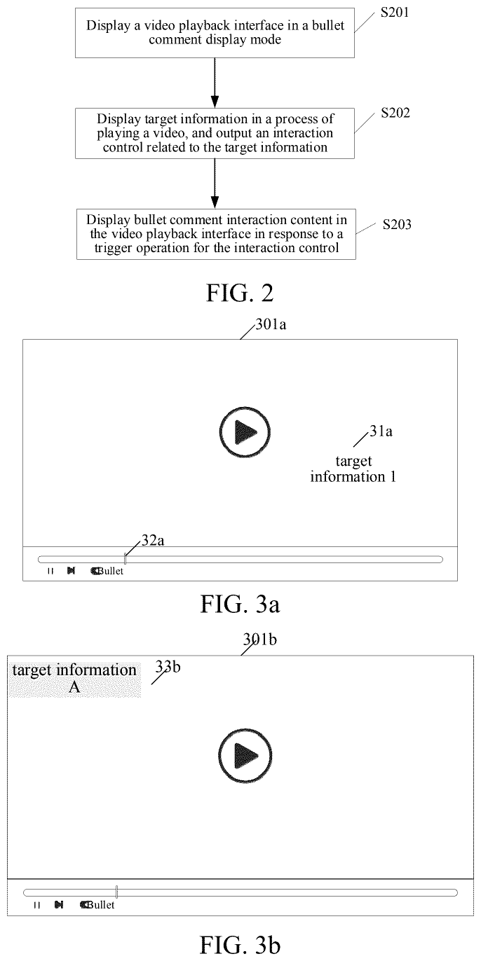

Referring to FIG. 2, FIG. 2 is a schematic flowchart of an information processing method according to an embodiment of the present disclosure. In this embodiment, the information processing method may be performed by a computer device, and the computer device may be any terminal in the foregoing information processing system. Referring to FIG. 2, the information processing method may include the following operation S201 to S203:

S201: Display a video playback interface in a bullet comment display mode.

When the video viewing object taps to enter a detail page of a video, a video playback interface configured for playing the video may be triggered to be displayed. When the video playback interface is in the bullet comment display mode, in a process of playing the video, playback content of the video and one or more pieces of bullet comment information are displayed in the video playback interface. The video may include but is not limited to: a live video, a 3D animation video, a VR video, an AR video, a game video, or the like. Correspondingly, the video playback interface may be an interface for a live video, an interface for playing a 3D animation video, an interface for playing a VR video, an interface for playing an AR video, an interface for playing a game video, or the like. The video and the video playback interface are not limited in the present disclosure.

S202: Display target information in a process of playing a video, and output an interaction control related to the target information.

In the process of playing the video, when the video is played to an placement point, the target information is displayed. The placement point of the target information may be a placement point preconfigured in the video based on target content add-on requirement; or the placement point is determined by a demand side in a plurality of placement points provisioned in the video. The placement point may include any one of the following: preset playback time in the video; and preset scene content in the video.

In some embodiments, the terminal may display the target information in the process of playing the video in the following manner: displaying the target information when playback time of the video reaches the preset playback time; or displaying the target information when the video is played to the preset scene content.

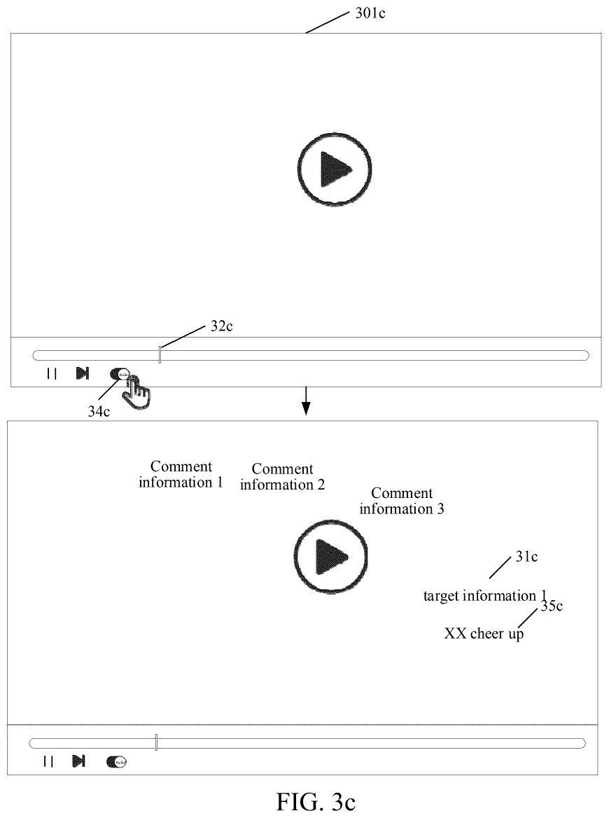

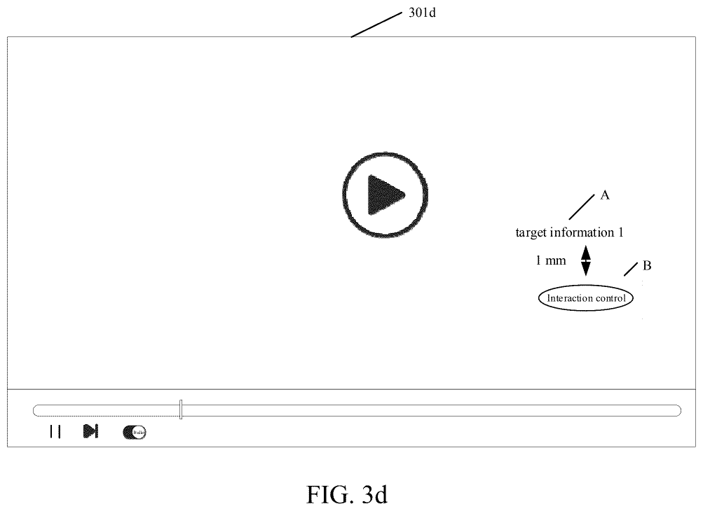

In an actual application, the placement point includes preset playback time in a video, and when playback time of the video reaches the preset playback time, the terminal may display target information in a video playback interface. The preset playback time may be any playback time point in the video. For example, the preset playback time may be the 21st minute in the video, the 5th second in the video, or the like. This is not limited in this embodiment of the present disclosure. For example, FIG. 3a is a schematic diagram of displaying target information according to an embodiment of the present disclosure. In FIG. 3a, when the playback time of the video reaches preset playback time 32, the terminal may display target information 1 in the video playback interface.

The placement point includes preset scene content in the video, and when the video is played to the preset scene content, the terminal may display the target information in the video playback interface. The preset scene content may include that a specific place (such as a high building or a bridge), a specific role (a character role in the video), a specific article (such as a knapsack or milky tea), a plurality of (at least two) camps fighting fiercely occur in the video, and the like occurs in the video. For example, the preset scene content includes a role A in the video. When the video is played to occurrence of the role A (that is, a video picture of the role A is displayed in the video playback interface), target information may be displayed in the video playback interface. In this case, the displayed target information may be associated with the role A. For example, the target information includes target information of a product endorsed by the role A. For another example, the preset scene content includes that a plurality of (at least two, using two as an example) camps fighting fiercely occurs. When the video is played to two camps fighting fiercely (that is, a video picture of two camps fighting fiercely is displayed in the video playback interface), target information may be displayed in the video playback interface. In this case, the displayed target information may be associated with the two camps. For example, the preset scene content includes two camps: gourmet 1 and gourmet 2, and the target information may include target information corresponding to gourmet 1 and gourmet 2.

The target information displayed in the video playback interface may be associated with a video that is currently played in the video playback interface. In this case, the association may refer to: The target information is associated with the video being played to the preset scene content, or the target information is associated with content presented by the video when the playback time reaches the preset playback time. For example, the preset scene content includes an XX-brand umbrella, and the target information is associated with the XX-brand umbrella. For example, the target information includes a function, a role, and the like of the XX-brand umbrella.

In some embodiments, the terminal may display the target information in the following manner: displaying the target information in any position region of the video playback interface; or displaying the target information in a fixed window or a floating window independent of the video playback interface; or displaying the target information in a sub-interface independent of the video playback interface.

A display position and a display manner of the target information may be flexibly set, and the display manner of the target information may include any one of the following: 1). The target information is displayed in any position region in the video playback interface. For example, in FIG. 3a, target information 1 is displayed in a position region 31a of a video playback interface 301a. For another example, the target information may be displayed in a right side region, a left side region, a lower side region, an upper side region, or the like of the video playback interface. This is not limited in this embodiment of the present disclosure. 2). The target information is displayed in a fixed window or a floating window independent of the video playback interface. For example, FIG. 3b is a schematic diagram of a display manner of target information according to an embodiment of the present disclosure. In FIG. 3b, target information A may be displayed in a fixed window 33b independent of a video playback interface 301b. 3). The target information is displayed in a sub-interface (that is, another interface different from the video playback interface) independent of the video playback interface. That is, when the playback time of the video reaches the preset playback time, or when the video is played to the preset scene content, the video playback interface may be switched to another interface (that is, the sub-interface), and the target information is displayed in the another interface.

A presentation form of the target information may be flexibly set, and the presentation form of the target information may include, but is not limited to: a video, a bullet comment, a text, a static picture, a dynamic picture, or the like. For example, the target information may be presented in a text form. For example, the target information may be “XX milk tastes good”. For another example, the target information may be presented in a form of a static picture. For example, the target information may be a brand corresponding to XX milk. For another example, the target information may be displayed by using a combination of a text and a static picture. For example, the target information may be a brand corresponding to XX Milk+“XX milk tastes good”. For another example, the target information is presented in a video form. That is, in a process of playing the video, a target information playback window independent of a video playback interface pops up, and the target information of a video type is played in the target information playback window. For example, the target information may be a video propaganda of XX milk by a spokesperson of XX milk. A presentation form of the target information is not limited in this embodiment of the present disclosure.

In some embodiments, the video playback interface includes a bullet comment display key. Before the video is played or in a process of playing the video, the bullet comment display key may be triggered. In response to a trigger operation (such as a tap operation, a double-tap operation, or a slide operation) for the bullet comment display key, the terminal may enable the bullet comment display mode in the video playback interface, may display the bullet comment information in the process of playing the video when the video playback interface is in the bullet comment display mode, and may display the target information and the bullet comment information in the video playback interface when the playback time of the video reaches the preset playback time or when the video is played to the preset scene content, or may display only the target information in the video playback interface. For example, FIG. 3c is a schematic diagram of a display manner of target information according to another embodiment of the present disclosure. In FIG. 3c, a bullet comment display key 34c is included in a video playback interface. In response to a tap operation on the bullet comment display key 34c, bullet comment information (the bullet comment information is, for example, comment information 1, comment information 2, and comment information 3 in FIG. 3c) is displayed in a video playback process. When playback time of the video reaches preset playback time (such as preset playback time 32c in FIG. 3c), the comment information 1, the comment information 2, and the comment information 3 may be displayed in the video playback interface 301c, and target information A is displayed at a region position 31c of the video playback interface 301c.

A video viewing object may trigger the bullet comment display key to enable and disable the bullet comment display mode. For example, when the video playback interface is in the bullet comment display mode, the terminal disables the bullet comment display mode in the video playback interface in response to a trigger operation for the bullet comment display key, that is, switches from the bullet comment display mode to a bullet comment shield mode. When the video playback interface is in the bullet comment shield mode, the bullet comment information is not displayed any more in the video playback process. When the video playback interface is in the bullet comment shield mode, the terminal enables the bullet comment display mode in the video playback interface in response to a trigger operation for the bullet comment display key, that is, switches from the bullet comment shield mode to the bullet comment display mode. When the video playback interface is in the bullet comment display mode, the bullet comment information may be displayed in the video playback process.

In some embodiments, the terminal may output the interaction control related to the target information in the following manner: outputting the interaction control related to the target information in a target output manner, the target output manner including at least one of the following: outputting the interaction control in a process of displaying the target information; outputting the interaction control at a display position of the target information; outputting the interaction control around the display position of the target information; and triggering output of the interaction control when the target information is selected.

In an actual application, following the displaying of the target information, the interaction control related to the target information may be output. The interaction control includes one of the following: a text control, an icon control, a voice control, and a key control. For example, when the interaction control includes a text control, for example, in FIG. 3c, the interaction control may be a text control 35 “XX cheer up”, and a trigger operation for the text control may be: tap, double-tap, or tap the text control a plurality of times within a period of time. When the interaction control is a voice control, a trigger operation for the voice control may be: tap, double-tap, a voice input operation, and the like.

An output manner of the interaction control may include at least one of the following: 1). Output the interaction control in a process of displaying target information. That is, the target information and the interaction control are displayed at the same time, and disappear at the same time. For example, in FIG. 3c, the text control 35c is output in the process of displaying the target information 1 at the same time. 2). The interaction control is outputted at the display position of the target information. For example, in FIG. 3c, the display position of the target information is the position 31c, and the interaction control (that is, the text control 35c) is output at the position 31c. In addition, in some embodiments, after the target information is displayed, the interaction control may be outputted at the display position of the target information within preset time (for example, 1 second or 10 seconds). 3). Output the interaction control around the display position of the target information, where “around” herein may be understood as: any position whose distance from the display position of the target information is less than a preset distance (for example, 1 mm or 0.1 mm). For example, FIG. 3d is a schematic diagram of outputting an interaction control at a display position of target information according to an embodiment of the present disclosure. Assuming that the preset distance is 1 mm, in FIG. 3d, the display position of the target information is a position A, the interaction control may be outputted at a position B (the interaction control is the interaction control shown in FIG. 3d), and a distance between the position A and the position B is less than 1 mm. \textcircled{4}. When the target information is selected, the interaction control is triggered to be outputted, where a selection operation on the target information may be an operation such as tap, double-tap, slide, long-press, or a plurality of taps in preset time on the target information.

S203: Display bullet comment interaction content in the video playback interface in response to a trigger operation for the interaction control.

There may be one or more pieces of bullet comment interaction content. In some embodiments, the bullet comment interaction content may be associated with the target information. For example, the target information includes XX milk, and the bullet comment interaction content includes “XX milk tastes good”. For another example, the target information includes a brand corresponding to XX milk, and the bullet comment interaction content includes the brand corresponding to XX milk and other interaction content. In some other embodiments, the target information is associated with a video, and then the bullet comment interaction content may also be associated with the video. For example, the video is a gourmet video, and the bullet comment interaction content may include comment information on gourmet.

A visual style of the bullet comment interaction content may be set flexibly, and the visual style of the bullet comment interaction content may include but is not limited to: a bullet comment, a text, a static picture, a dynamic picture (dynamic GIF), and the like.

A manner for triggering the interaction control may be set flexibly, and the manner for triggering the interaction control may include any one of the following: a tap operation on the interaction control, a long-press operation on the interaction control, a slide operation on the interaction control along a target direction (for example, leftward, rightward, upward, or downward), a shake operation on the interaction control, a flip operation on the interaction control, an incline operation on the interaction control, a pinch operation on the interaction control, and the like.

In some embodiments, when the interaction control is configured to prompt to participate in interaction with the target information, the terminal may display the bullet comment interaction content in the video playback interface in at least one of the following manners: displaying the bullet comment interaction content in the video playback interface in an arranged manner; displaying the bullet comment interaction content in the video playback interface in a floating manner; dynamically displaying the bullet comment interaction content in the video playback interface; and displaying the bullet comment interaction content in a fixed region of the video playback interface.

In an actual application, the interaction control may be configured to prompt to interact with the target information. When the interaction control is triggered, interaction with the target information may be implemented, that is, the bullet comment interaction content obtained by interacting with the target information is displayed in the video playback interface.

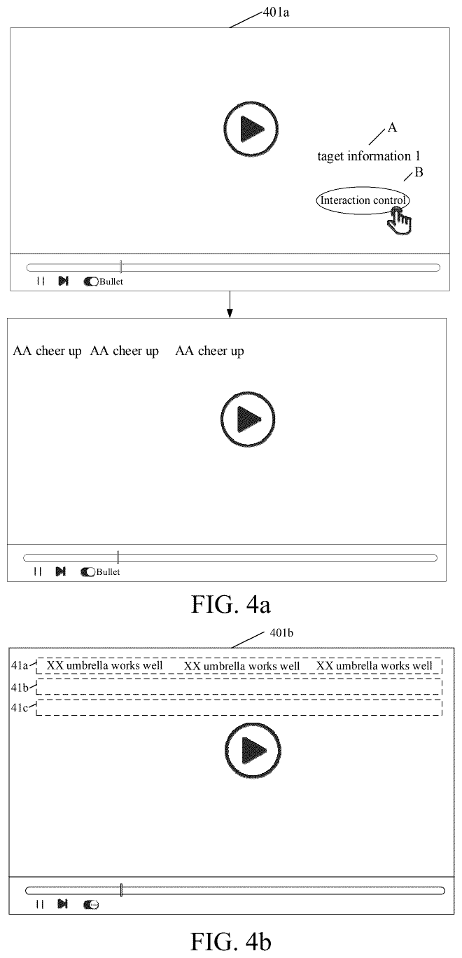

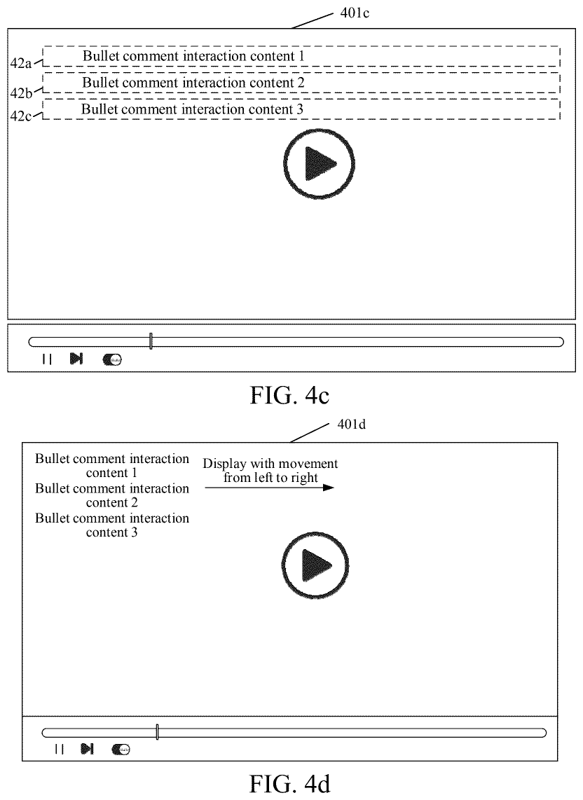

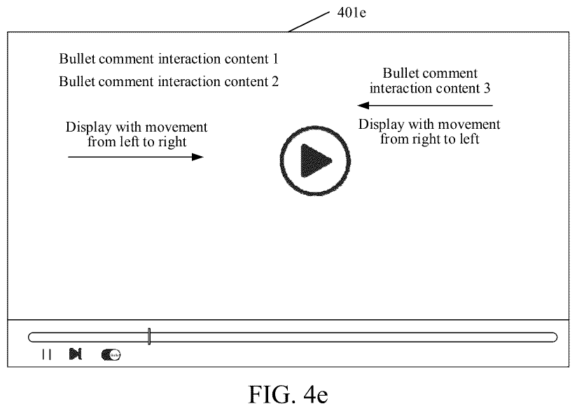

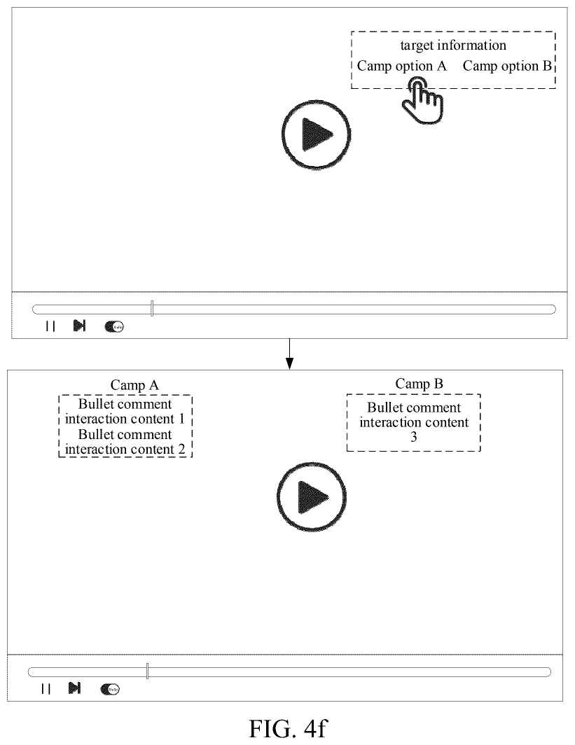

There may be one or more pieces of bullet comment interaction content. Assuming that a quantity of bullet comment interaction content is a target quantity: N, where N is a positive integer, and a value of N may change as a quantity of interaction participation objects dynamically changes. For example, N=2, 3, or 10. For example, FIG. 4a is a schematic diagram of displaying N pieces of bullet comment interaction content according to an embodiment of the present disclosure. When an interaction participation object triggers (for example, taps) an interaction control, in response to the trigger operation for the interaction control, the terminal displays N (for example, 3) pieces of bullet comment interaction content, which are respectively AA cheer up, AA cheer up, and AA cheer up, in a video playback interface 401a.

In an actual application, when N is greater than or equal to 2, the N pieces of bullet comment interaction content may be the same or different. That the N pieces of bullet comment interaction content are different may mean that: content of the bullet comment interaction content is different (for example, one piece of bullet comment interaction content is “A is great”, and another piece of bullet comment interaction content is “A cheer up”, font sizes of the bullet comment interaction content are different (for example, a font of one piece of bullet comment interaction content is little four, and a font of another piece of bullet comment interaction content is little five), and font colors of the bullet comment interaction content are different (for example, a font of one piece of bullet comment interaction content is red, and a font of another piece of bullet comment interaction content is blue).

The displaying the bullet comment interaction content in the video playback interface may include at least one of the following:

1). Display the N pieces of bullet comment interaction content in the video playback interface in an arranged manner. In some embodiments, the N pieces of bullet comment interaction content may be displayed in a horizontal arrangement in the video playback interface. For example, as shown in FIG. 4a, N=3, and the three pieces of bullet comment interaction content are respectively “AA cheer up”, “AA cheer up”, and “AA cheer up”. “AA cheer up”, “AA cheer up”, and “AA cheer up” are displayed in a horizontal arrangement in the video playback interface. In some other embodiments, the N pieces of bullet comment interaction content may be displayed in a longitudinal arrangement in the video playback interface.

In some embodiments, the video playback interface includes one or more display tracks, and the terminal may display the N pieces of bullet comment interaction content in a horizontal arrangement in one display track. For example, FIG. 4b is a schematic diagram of displaying N pieces of bullet comment interaction content in an arranged manner according to an embodiment of the present disclosure. A video playback interface 401b includes three display tracks (that is, a display track 41a, a display track 41b, and a display track 41c), and three pieces of bullet comment interaction content (that is, XX umbrella works well, XX umbrella works well, and XX umbrella works well in FIG. 4b) are displayed in a horizontal arrangement in the display track 41a. Alternatively, the terminal may display the N pieces of bullet comment interaction content in a longitudinal arrangement in a plurality of display tracks. For example, FIG. 4c is a schematic diagram of displaying N pieces of bullet comment interaction content in an arranged manner according to still another embodiment of the present disclosure. A video playback interface 401c includes three display tracks (that is, a display track 42a, a display track 42b, and a display track 42c), and then three pieces of bullet comment interaction content are displayed in a longitudinal arrangement in the three display tracks. That is, in FIG. 4c, bullet comment interaction content 1 is displayed in an arranged manner in the display track 42a bullet comment interaction content 2 is displayed in an arranged manner in the display track 42b, and bullet comment interaction content 3 is displayed in an arranged manner in the display track 42c.

2). Display the N pieces of bullet comment interaction content in the video playback interface in a floating manner, where displaying in a floating manner means that the bullet comment interaction content is displayed above the video playback interface.

3). Dynamically display the N pieces of bullet comment interaction content in the video playback interface, where the dynamic display may include at least one of the following: The N pieces of bullet comment interaction content are displayed in the video playback interface in a movement manner, the N pieces of bullet comment interaction content are displayed in the video playback interface in a flickering manner, and the N pieces of bullet comment interaction content are updated and displayed within a period of time (for example, 1 second or 2 minutes).

The displaying the N pieces of bullet comment interaction content in the video playback interface in a movement manner may include: (1) Display the N pieces of bullet comment interaction content in the video playback interface in a movement manner along a preset moving direction (for example, from right to left, from left to right, or from top to bottom). For example, FIG. 4d is a schematic diagram of displaying N pieces of bullet comment interaction content in a movement manner according to an embodiment of the present disclosure. In FIG. 4d, bullet comment interaction content 1, bullet comment interaction content 2, and bullet comment interaction content 3 are displayed in a movement manner from left to right in a video playback interface 401d. (2) Display the N pieces of bullet comment interaction content in the video playback interface in a cross movement manner. For example, some of the N pieces of bullet comment interaction content are displayed in a movement manner from right to left, and remaining bullet comment interaction content of the N pieces of bullet comment interaction content may be displayed in a movement manner from left to right, to implement cross movement display of the N pieces of bullet comment interaction content. For example, FIG. 4e is a schematic diagram of displaying N pieces of bullet comment interaction content in a movement manner according to another embodiment of the present disclosure. In FIG. 4e, in a video playback interface 401e, bullet comment interaction content 1 and bullet comment interaction content 2 are displayed in a movement manner from left to right, and bullet comment interaction content 3 is displayed in a movement manner from right to left. (3) Display the N pieces of bullet comment interaction content in the video playback interface at the same moving rate or at different moving rates. For example, the N pieces of bullet comment interaction content include: bullet comment interaction content XXX and bullet comment interaction content X. The bullet comment interaction content XXX may be displayed at 3.3 words per second, and the bullet comment interaction content X may be displayed at 4 words per second in the video playback interface. (4) Display the N pieces of bullet comment interaction content in the video playback interface in a movement manner according to a target pattern. For example, the N pieces of bullet comment interaction content are displayed around a “heart” pattern in a movement manner.

4). Display the N pieces of bullet comment interaction content in a fixed region of the video playback interface. The fixed region may be a left position, a right position, a middle position, or the like in the video playback interface. This is not limited in this embodiment of the present disclosure.

Bullet comment interaction content in a full screen may be distributed by triggering the interaction control (that is, the N pieces of bullet comment interaction content are all displayed in the entire video playback interface). Not only interaction between an interaction participation object and target information can be implemented, but also an atmosphere of strong add-on content social interaction can be created, thereby improving a social effect while improving an add-on content interaction effect.

In some embodiments, after the bullet comment interaction content is displayed in the video playback interface, the displayed bullet comment interaction content may be closed according to a requirement. In some embodiments, closing time may be set. When the display time of the bullet comment interaction content reaches the closing time, the displayed bullet comment interaction content is closed. For example, the closing time is two hours, and when the display time of the bullet comment interaction content reaches 2 hours, the displayed bullet comment interaction content is closed. In some other embodiments, the video playback interface includes an interaction close option, and when the interaction close option is triggered, the displayed bullet comment interaction content is closed.

In this embodiment of the present disclosure, target information is displayed in a process of playing a video, and an interaction control related to the target information is outputted; and bullet comment interaction content is displayed in the video playback interface in response to a trigger operation for the interaction control. In this way, an interaction control related to target information is set, and interaction with the target information can be implemented by triggering the interaction control. In this way, an add-on content interaction form is expanded. In addition, the bullet comment interaction content triggered and presented by using the interaction control enriches presentation forms of the target information, and implements interaction with the target information, thereby improving interactivity with the target information.

In some embodiments, when the interaction control is configured to prompt to participate in interaction in content confrontation, the content confrontation includes at least a first camp and a second camp, and the bullet comment interaction content includes a first bullet comment interaction content belonging to the first camp and a second bullet comment interaction content belonging to the second camp, the terminal may display the bullet comment interaction content in the video playback interface in at least one of the following manners: differently displaying the first bullet comment interaction content and the second bullet comment interaction content in the video playback interface; displaying the first bullet comment interaction content and the second bullet comment interaction content in the video playback interface in a confrontational manner; displaying the first bullet comment interaction content and the second bullet comment interaction content in the video playback interface by regions; and displaying the first bullet comment interaction content and the second bullet comment interaction content in the video playback interface alternately in time periods; the differently displaying including one of the following: display in different colors, display in different brightness, display in different shapes, and display in different sizes.

In an actual application, in addition to prompting to participate in interaction with the target information, the interaction control may further be configured to prompt to participate in interaction in content confrontation in the target information. When the interaction control is configured to prompt to participate in interaction of the content confrontation in the target information, the target information is actually related information for promoting the content confrontation. The content confrontation may include a plurality of camps. Correspondingly, the interaction control may include a camp option corresponding to each of the plurality of camps. That is, one interaction control (or camp option) corresponds to one camp. An interaction participation object may trigger a corresponding camp option to enter a camp corresponding to the camp option. For example, the content confrontation may include at least a first camp and a second camp. Correspondingly, the interaction control may include at least a first camp option and a second camp option. When the interaction participation object triggers the first camp option in the interaction control, the terminal controls, in response to the trigger operation, the interaction participation object to choose to join the first camp, and allocates, to the interaction participation object, interaction data associated with the first camp as the bullet comment interaction content. That is, the bullet comment interaction content in this case belongs to the first camp. When the interaction participation object triggers the second camp option in the interaction control, the terminal controls, in response to the trigger operation, the interaction participation object to choose to join the second camp, and allocates, to the interaction participation object, interaction data associated with the second camp as the bullet comment interaction content. That is, the bullet comment interaction content in this case belongs to the second camp.

The bullet comment interaction content may include bullet comment interaction content belonging to different camps. For example, the bullet comment interaction content includes M pieces of first bullet comment interaction content belonging to the first camp and P pieces of second bullet comment interaction content belonging to the second camp, where M and P are both positive integers, a value of M supports a dynamic change in a quantity of interaction participation objects that join the first camp, and a value of P supports a dynamic change in a quantity of interaction participation objects that join the second camp. In this case, the displaying, by the terminal, bullet comment interaction content in the video playback interface in response to a trigger operation for the interaction control may include: displaying bullet comment interaction content belonging to different camps (that is, the first bullet comment interaction content and the second bullet comment interaction content) in the video playback interface in response to the trigger operation for the interaction control. For example, FIG. 4f shows that bullet comment interaction content belonging to different camps is displayed in the video playback interface according to an embodiment of the present disclosure. In FIG. 4f, the interaction control includes a camp option A (that is, the camp option A corresponds to the camp A) and a camp option B (that is, the camp option B corresponds to the camp B). When the camp option A is triggered, bullet comment interaction content belonging to the camp A (that is, the bullet comment interaction content 1 and the bullet comment interaction content 2) and bullet comment interaction content belonging to the camp B (that is, the bullet comment interaction content 3) may be displayed in the video playback interface.

The displaying, by the terminal, bullet comment interaction content belonging to different camps in the video playback interface may include at least one of the following:

(1) Differently display bullet comment interaction content belonging to different camps in the video playback interface, that is, differently display the first bullet comment interaction content (belonging to the first camp) and the second bullet comment interaction content (belonging to the second camp) in the video playback interface.

The differently displaying may include any one of the following: 1). Display bullet comment interaction content belonging to different camps in different colors. For example, the first bullet comment interaction content belonging to the first camp may be displayed in red, and the second bullet comment interaction content belonging to the second camp may be displayed in green. 2). Display bullet comment interaction content belonging to different camps with different brightness. For example, the first bullet comment interaction content belonging to the first camp may be displayed in a bright state (that is, brightness is greater than preset brightness), and the second bullet comment interaction content belonging to the second camp may be displayed in a dark state (brightness is less than the preset brightness). 3). Display bullet comment interaction content belonging to different camps in different shapes. For example, bullet comment interaction content belonging to different camps may be displayed in different bullet comment shapes, and the bullet comment shapes may include but are not limited to: a circle, a rectangular frame, an irregular shape, and the like, which are not limited in this embodiment of the present disclosure. For example, the first bullet comment interaction content belonging to the first camp may be displayed in a bullet comment rectangular box, and the second bullet comment interaction content belonging to the second camp may be displayed in a bullet comment hexagon. 4). Display bullet comment interaction content belonging to different camps in different sizes. When the bullet comment interaction content includes an add-on content interaction text, the size herein may be a font size corresponding to the add-on content interaction text. For example, the first bullet comment interaction content belonging to the first camp includes “role 1 is great”, and the second bullet comment interaction content belonging to the second camp includes “role 2 is great”. “Role 1 is great” may be displayed in a font little four, and “role 2 is great” may be displayed in a font little five. When the bullet comment interaction content includes an add-on content interaction picture, the size herein may be a picture size of the add-on content interaction picture. 5). Display bullet comment interaction content belonging to different camps in different thickness. For example, the first bullet comment interaction content belonging to the first camp may be displayed in bold, and the second bullet comment interaction content belonging to the second camp may be displayed normally (that is, not bold).

The foregoing differential display may be flexibly selected for use, or may be used in a combination. For example, the foregoing manners (1) and (3) are combined. For example, the first bullet comment interaction content belonging to the first camp may be displayed as a red rectangular bullet comment, and the second bullet comment interaction content belonging to the second camp may be displayed as a green circular bullet comment. For another example, the foregoing manners (4) and (5) are combined. For example, the font of the first bullet comment interaction content belonging to the first camp is little four and is displayed in bold, and the font of the second bullet comment interaction content belonging to the second camp is little five and is displayed normally (not bold). For another example, (3), (4), and (5) may also be used in combination. By means of the foregoing combinations of differential display, the content confrontation can be made more flexible and interesting, thereby improving an add-on content interaction effect and a social effect.

(2) Display bullet comment interaction content belonging to different camps in the video playback interface in a confrontational manner. That is, using an example in which the different camps include the first camp and the second camp, the first bullet comment interaction content (belonging to the first camp) and the second bullet comment interaction content (belonging to the second camp) are displayed in the video playback interface in a confrontational manner.

The confrontational display may include at least one of the following:

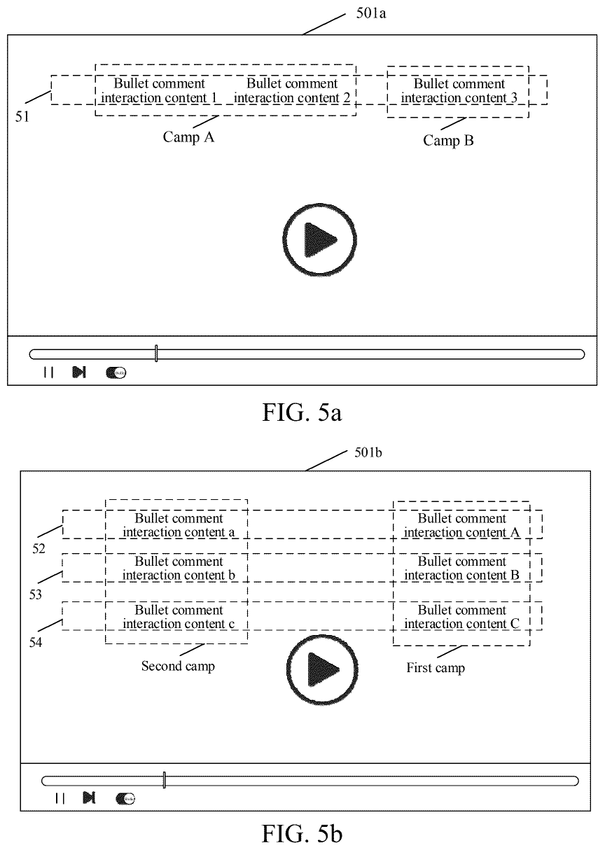

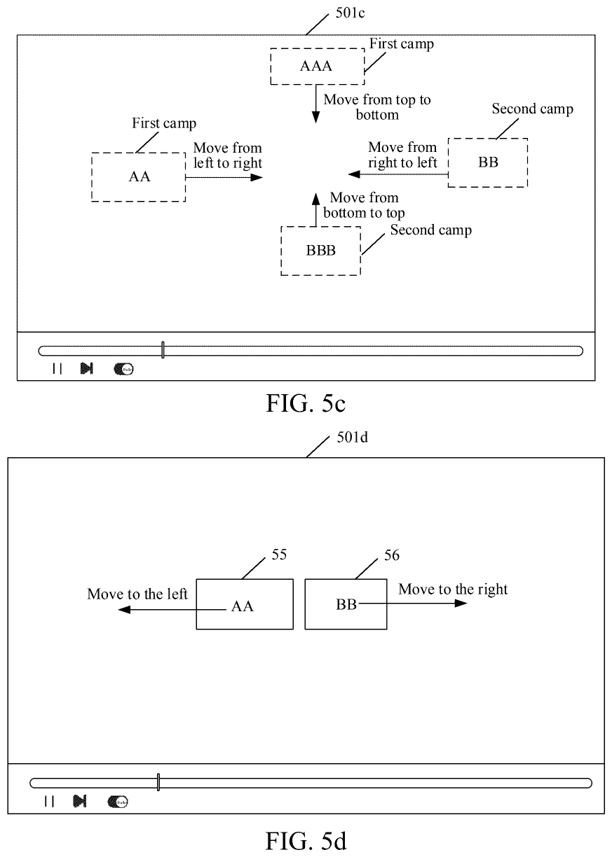

1). The video playback interface is provided with one or more display tracks, and bullet comment interaction content belonging to different camps is displayed in the same display track of the video playback interface in a movement manner. For example, FIG. 5a is a schematic diagram of displaying bullet comment interaction content belonging to different camps in the same display track in a movement manner according to an embodiment of the present disclosure. In FIG. 5a, a video playback interface 501a includes one display track 51, and two pieces of bullet comment interaction content (that is, bullet comment interaction content 1 and bullet comment interaction content 2) belonging to a camp A and one piece of bullet comment interaction content (that is, bullet comment interaction content 3) belonging to a cams B are separately displayed in the display track 51.

Bullet comment interaction content belonging to different camps may be displayed in a plurality of display tracks of the video playback interface. For example, FIG. 5b is a schematic diagram of displaying bullet comment interaction content belonging to different camps in a plurality of display tracks according to an embodiment of the present disclosure. In FIG. 5b, a video playback interface 501b includes three display tracks, which are respectively a display track 52, a display track 53, and a display track 54. First bullet comment interaction content A belonging to a first camp and second bullet comment interaction content a belonging to a second camp are displayed in the display track 52 in a movement manner; first bullet comment interaction content b belonging to the first camp and second bullet comment interaction content b belonging to the second camp are displayed in the display track 53 in a movement manner; and first bullet comment interaction content c belonging to the first camp and second bullet comment interaction content c belonging to the second camp are displayed in the display track 54 in a movement manner.

2). Display bullet comment interaction content belonging to different camps in the video playback interface with movement toward each other. That is, using an example in which the different camps include the first camp and the second camp, the first bullet comment interaction content (belonging to the first camp) and the second bullet comment interaction content (belonging to the second camp) are displayed in the video playback interface with movement toward each other.

The displaying with movement toward each other may include: displaying M pieces of first bullet comment interaction content belonging to the first camp in the video playback interface in a movement manner along a first moving direction, and P pieces of second bullet comment interaction content belonging to the second camp in a movement manner along a second moving direction, where the first moving direction and the second moving direction are two opposite directions, for example, the first moving direction is from left to right, and the second moving direction is from right to left. For another example, the first moving direction is from top to bottom, and the second moving direction is from bottom to top. The first moving direction and the second moving direction are not limited in this embodiment of the present disclosure.

For example, FIG. 5c is a schematic diagram of displaying bullet comment interaction content belonging to different camps in a video playback interface with movement toward each other according to an embodiment of the present disclosure. In FIG. 5c, two pieces of first bullet comment interaction content belonging to a first camp include “AA” and “AAA”, two pieces of second bullet comment interaction content belonging to a second camp include “BB” and “BBB”, “AA” belonging to the first camp is displayed in a movement manner from left to right, and “BB” belonging to the second camp is displayed in a movement manner from right to left in a video playback interface 501c. “AAA” belonging to the first camp is displayed in a movement manner from top to bottom, and “BBB” belonging to the second camp is displayed in a movement manner from bottom to top.

3). Display bullet comment interaction content belonging to different camps in the video playback interface with movement in opposite directions. That is, using an example in which the different camps include the first camp and the second camp, the first bullet comment interaction content (belonging to the first camp) and the second bullet comment interaction content (belonging to the second camp) are displayed in the video playback interface with movement in opposite directions.

The displaying with movement in opposite directions may include: In the video playback interface, the first bullet comment interaction content belonging to the first camp and the second bullet comment interaction content belonging to the second camp are displayed from the same position with movement in opposite directions. Certainly, the first bullet comment interaction content belonging to the first camp and the second bullet comment interaction content belonging to the second camp may be displayed from different positions with movement in opposite directions. For example, FIG. 5d is a schematic diagram of displaying bullet comment interaction content belonging to different camps in a video playback interface with movement in opposite directions according to an embodiment of the present disclosure. In FIG. 5d, M pieces of first bullet comment interaction content belonging to the first camp include first bullet comment interaction content “AA”, P pieces of second bullet comment interaction content belonging to the second camp include second bullet comment interaction content “BB”, and the first bullet comment interaction content “AA” and the second bullet comment interaction content “BB” are displayed from different positions in a video playback interface 501d with movement in opposite directions. That is, in FIG. 5d, the first bullet comment interaction content “AA” may be moved to the left from a position 55 for display, and the second bullet comment interaction content “BB” is moved to the right from a position 56 for display. The position 55 and the position 56 may be any positions in the video playback interface. This is not limited in this embodiment of the present disclosure.

When bullet comment interaction content belonging to different camps is displayed with movement in opposite directions or bullet comment interaction content belonging to different camps is displayed with movement toward each other, directions in which the bullet comment interaction content of different camps is moved may be preset. For example, if the first camp is set to be displayed in a movement manner along the first moving direction, the first bullet comment interaction content belonging to the first camp is displayed in the video playback interface in a movement manner along the first moving direction. If the second camp is set to be displayed in a movement manner along the second moving direction, the second bullet comment interaction content belonging to the second camp is displayed in the video playback interface in a movement manner along the second moving direction. When the interaction participation object chooses to join a specific camp, the bullet comment interaction content allocated to the interaction participation object is displayed in a movement manner according to a moving direction corresponding to the camp.

4). When bullet comment interaction content belonging to different camps is moved to the same display position of the video playback interface, a confrontational effect is presented between bullet comment interaction content belonging to different camps in the video playback interface. That is, using an example in which the different camps include a first camp and a second camp, when the first bullet comment interaction content and the second bullet comment interaction content are moved to the same display position of the video playback interface, a confrontational effect is presented between the first bullet comment interaction content and the second bullet comment interaction content in the video playback interface.

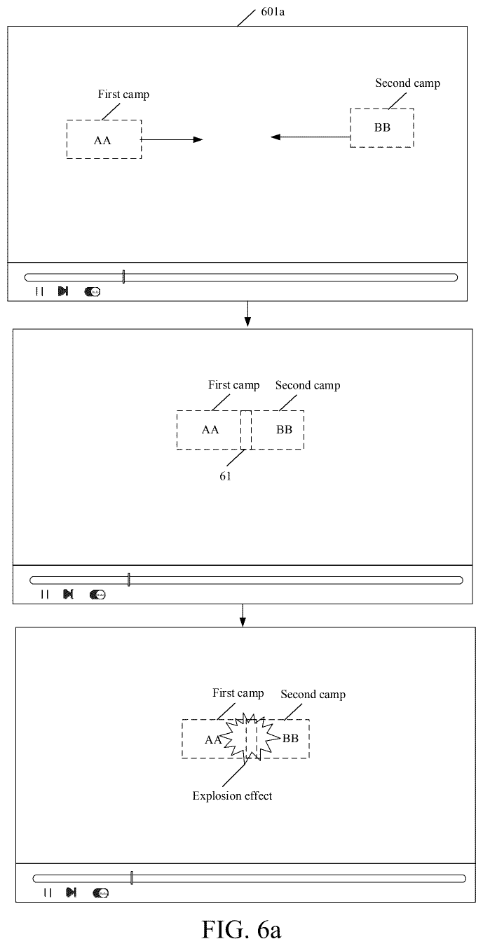

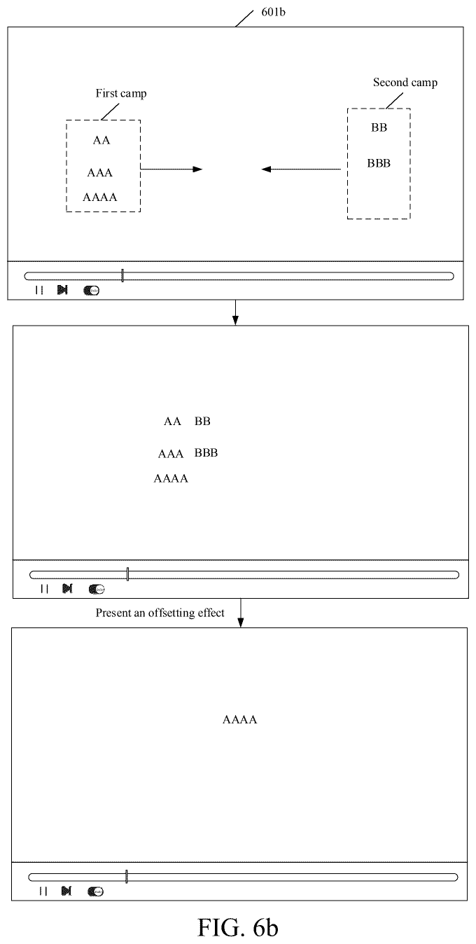

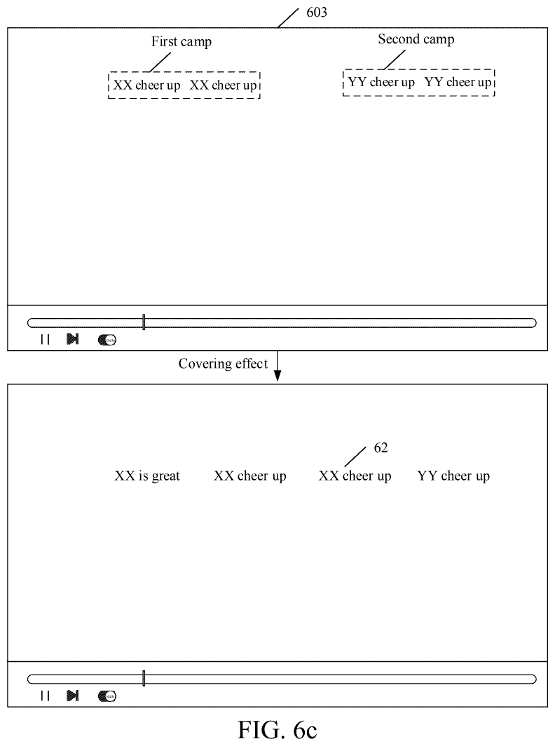

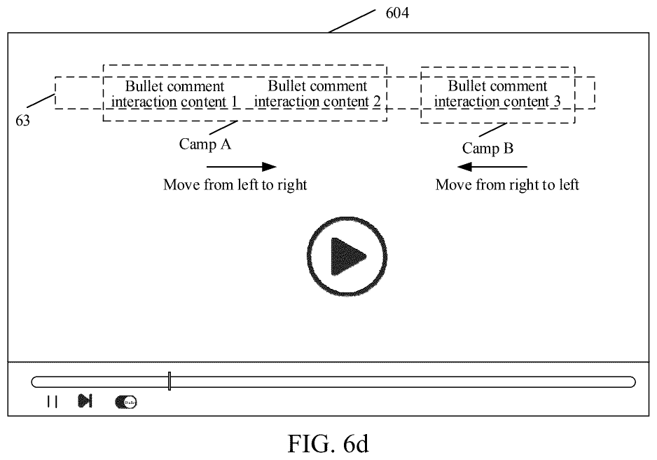

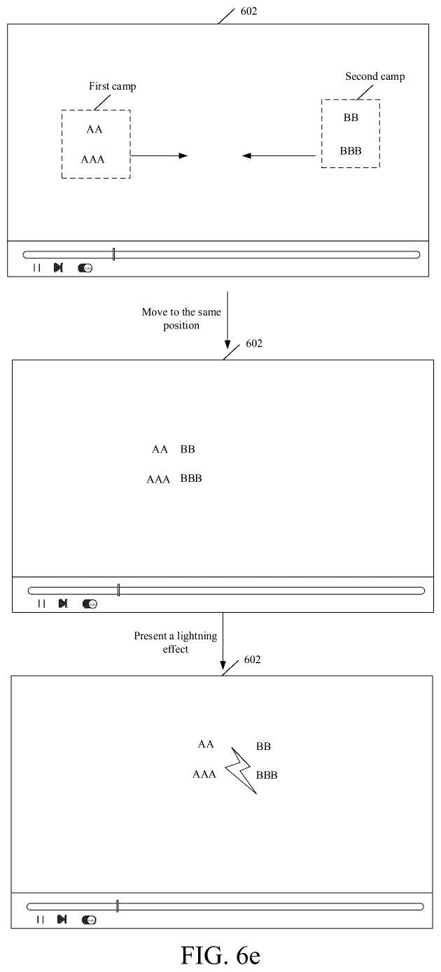

The display position may be any position in the video playback interface. For example, the display position may be a left position, a right position, an upper left position, a middle position, or the like in the video playback interface. For example, FIG. 6a is a schematic diagram of presenting a confrontational effect between bullet comment interaction content belonging to different camps in a video playback interface according to an embodiment of the present disclosure. In FIG. 6a, when first bullet comment interaction content “AA” belonging to a first camp and second bullet comment interaction content “BB” belonging to a second camp are moved to the same display position 61 of a video playback interface 601a, a confrontational effect is presented between the first bullet comment interaction content “AA” and the second bullet comment interaction content “BB” in the video playback interface 601a (for example, an explosive effect is presented).

5). A confrontational effect is presented between bullet comment interaction content belonging to different camps in the video playback interface based on a quantity relationship between the bullet comment interaction content belonging to the different camps. That is, using an example in which the different camps include the first camp and the second camp, a confrontational effect is presented between the first bullet comment interaction content and the second bullet comment interaction content in the video playback interface based on a quantity relationship (that is, a quantity relationship between M and P) between a first quantity (that is, M) of the first bullet comment interaction content and a second quantity (that is, P) of the second bullet comment interaction content.

For example, when M is equal to P, a confrontational effect is presented between the first bullet comment interaction content and the second bullet comment interaction content in the video playback interface. When a difference between M and P is greater than a quantity difference threshold, a confrontational effect is presented between the first bullet comment interaction content and the second bullet comment interaction content in the video playback interface. When M is greater than P and M is greater than a quantity threshold, a confrontational effect is presented between the first bullet comment interaction content and the second bullet comment interaction content in the video playback interface. Alternatively, when P is greater than M, and P is greater than a quantity threshold, a confrontational effect is presented between the first bullet comment interaction content and the second bullet comment interaction content in the video playback interface.

The confrontational effect includes any one of the following: an offsetting effect, a covering effect, a lightning effect, an electrical light flickering effect, a wind and snow effect, a tearing effect, an explosion effect, a screen dominance effect, and a sparking effect.

The offsetting effect means that bullet comment interaction content (which may be some bullet comment interaction content) belonging to different camps may be displayed in an offset manner. For example, target first bullet comment interaction content (some of M pieces of first bullet comment interaction content) of the first camp and target second bullet comment interaction content (some of P pieces of second bullet comment interaction content) of the second camp may be displayed in an offset manner. In other words, the displaying in an offset manner refers to deleting the target first bullet comment interaction content and the target second bullet comment interaction content from the video playback interface, and skipping displaying the target first bullet comment interaction content and the target second bullet comment interaction content after the target first bullet comment interaction content and the target second bullet comment interaction content are offset. For example, FIG. 6b is a schematic diagram of presenting an offsetting effect between bullet comment interaction content belonging to different camps in a video playback interface according to an embodiment of the present disclosure. In FIG. 6b, M pieces of first bullet comment interaction content belonging to the first camp in a video playback interface 601b include first bullet comment interaction content “AA”, first bullet comment interaction content “AAA” and first bullet comment interaction content “AAAA”. P pieces of second bullet comment interaction content belonging to the second camp in the video playback interface include second bullet comment interaction content “BB” and second bullet comment interaction content “BBB”. When the first bullet comment interaction content belonging to the first camp and the second bullet comment interaction content belonging to the second camp in the video playback interface are moved to the same display position of the video playback interface, the first bullet comment interaction content belonging to the first camp and the second bullet comment interaction content belonging to the second camp present an offsetting effect. In FIG. 6b, the first bullet comment interaction content “AA”, the first bullet comment interaction content “AAA”, the second bullet comment interaction content “BB”, and the second bullet comment interaction content “BBB” are offset and deleted, and only the first bullet comment interaction content “AAAA” is displayed in the video playback interface.

The displaying in an offset manner herein may include: 1). Quantity offsetting, that is, in FIG. 6b, the quantity M of first bullet comment interaction content belonging to the first camp is 3, and the quantity P of second bullet comment interaction content belonging to the second camp is 2. Through quantity offsetting, only the first bullet comment interaction content “AAAA” is displayed in the video playback interface. 2). Bullet comment interaction content belonging to different camps and whose text lengths are the same is offset. If a text length of the first bullet comment interaction content “AA” belonging to the first camp is two characters, and a text length of the second bullet comment interaction content “BB” belonging to the second camp is two characters, the first bullet comment interaction content “AA” and the second bullet comment interaction content “BB” are displayed in an offset manner. 3). First bullet comment interaction content and second bullet comment interaction content that are located at the same display position are displayed in an offset manner.

The covering effect refers to covering bullet comment interaction content of another camp with bullet comment interaction content of any camp. For example, FIG. 6c is a schematic diagram of presenting a covering effect between bullet comment interaction content belonging to different camps in a video playback interface according to an embodiment of the present disclosure. In FIG. 6c, M pieces of first bullet comment interaction content belonging to the first camp include: “XX is great”, “XX cheer up”, and “XX cheer up”. P pieces of second bullet comment interaction content belonging to the second camp include: “YY cheer up” and “YY cheer up”. Presenting a covering effect between first bullet comment interaction content belonging to the first camp and second bullet comment interaction content belonging to the second camp includes: In a video playback interface 603, “XX cheer up” belonging to the first camp covers “YY cheer up” belonging to the second camp, and the covering effect may be shown as 62 in FIG. 6c.

The screen dominance effect means that bullet comment interaction content of any camp occupies an entire video playback interface. In other words, only bullet comment interaction content of a specific camp is displayed in the video playback interface. For example, the video playback interface displays only the first bullet comment interaction content of the first camp.

Based on a quantity relationship between M and P, a corresponding confrontational effect may be selected from different confrontational effects for bullet comment interaction content belonging to different camps, and the selected confrontational effect is presented between the bullet comment interaction content belonging to different camps in the video playback interface.

In some embodiments, the confrontational effect includes the covering effect or the screen dominance effect. The terminal may present a confrontational effect between the first bullet comment interaction content and the second bullet comment interaction content in the video playback interface in the following manner when a first quantity of the first bullet comment interaction content is greater than a second quantity of the second bullet comment interaction content and the first quantity is greater than a quantity threshold: adjusting opacities of layers on which all or some of the second bullet comment interaction content in the video playback interface is located from a first value to a second value when the first quantity of the first bullet comment interaction content is greater than the second quantity of the second bullet comment interaction content and the first quantity is greater than the quantity threshold; and removing all or some of adjusted second bullet comment interaction content from a display track, and displaying the first bullet comment interaction content in the display track.

In an actual application, when M is greater than P, and M is greater than a quantity threshold, or when P is greater than M, and P is greater than a quantity threshold, a covering effect or a screen dominance effect may be selected for bullet comment interaction content belonging to different camps. For example, when M is greater than P, and M is greater than a quantity threshold, a covering effect or a screen dominance effect may be selected for bullet comment interaction content belonging to different camps. In this case, presenting a confrontational effect between bullet comment interaction content belonging to different camp in the video playback interface may include: adjusting opacities of layers on which all or some of the second bullet comment interaction content in the video playback interface is located from a first value (for example, 1) to a second value (for example, 0) when M is greater than P and M is greater than a quantity threshold; and removing all or some of adjusted second bullet comment interaction content from a display track, and displaying the first bullet comment interaction content belonging to the first camp in the display track. In some embodiments, the opacities of all or some of the layers on which the second bullet comment interaction content is located in the video playback interface may be adjusted from the first value (for example, 1) to the second value within time t0 (for example, 3 seconds or 10 minutes).

When the opacities of the layers on which all the second bullet comment interaction content in the video playback interface is located are adjusted from the first value (for example, 1) to the second value, a screen dominance effect is presented between M (that is, the first quantity) pieces of first bullet comment interaction content belonging to the first camp and P (that is, the second quantity) pieces of second bullet comment interaction content belonging to the second camp (that is, only the first bullet comment interaction content belonging to the first camp appears in the video playback interface). When the opacities of the layers on which some second bullet comment interaction content in the video playback interface is located are adjusted from the first value (for example, 1) to the second value, a covering effect is presented between the M pieces of first bullet comment interaction content belonging to the first camp and the P pieces of second bullet comment interaction content belonging to the second camp. That is, the M pieces of first bullet comment interaction content belonging to the first camp cover the adjusted some second bullet comment interaction content, until the M pieces of first bullet comment interaction content belonging to the first camp cover all the second bullet comment interaction content, thereby occupying the entire video playback interface.

When P is greater than M and P is greater than the quantity threshold, the opacities of the layers on which all or some of the first bullet comment interaction content in the video playback interface is located are adjusted from the first value (for example, 1) to the second value (for example, 0); and all or some of adjusted first bullet comment interaction content are removed from the display track, and the second bullet comment interaction content belonging to the second camp is displayed in the display track. In some embodiments, the opacities of all or some of the layers on which the first bullet comment interaction content is located in the video playback interface may be adjusted from the first value (for example, 1) to the second value within time t0 (for example, 3 seconds or 10 minutes).

In some embodiments, the terminal may present a confrontational effect between the first bullet comment interaction content and the second bullet comment interaction content in the video playback interface in the following manner: determining that first bullet comment interaction content and second bullet comment interaction content that have a collision exist in the video playback interface; performing position separation on the first bullet comment interaction content and the second bullet comment interaction content that have a collision, and adding a layer corresponding to a confrontational effect at a separated position; and rendering the layer corresponding to the confrontational effect, to present the confrontational effect.

In an actual application, when M is equal to P, a lightning effect, a wind and snow effect, a tearing effect, an explosion effect, a sparking effect, and the like may be selected for bullet comment interaction content belonging to different camps. In this case, presenting a confrontational effect between bullet comment interaction content belonging to different camps in the video playback interface includes: determining that first bullet comment interaction content and second bullet comment interaction content that have a collision exist in the video playback interface; performing position separation on the first bullet comment interaction content and the second bullet comment interaction content that have a collision, and adding a layer (AnimationPlayer) corresponding to a confrontational effect at a separated position, where the layer may be configured for playing the confrontational effect; and rendering the layer corresponding to the confrontational effect, to present the confrontational effect.

In some embodiments, performing position separation on first bullet comment interaction content and second bullet comment interaction content that have a collision may be performing position separation on positions corresponding to initial elements that are determined to have a collision and that are between the first bullet comment interaction content and the second bullet comment interaction content. For example, first bullet comment interaction content “AA is great” and second bullet comment interaction content “BB cheer up” have a collision. First elements that have a collision between the first bullet comment interaction content “AA is great” and the second bullet comment interaction content “BB cheer up” are respectively “great” and “B”. Performing position separation on the first bullet comment interaction content and the second bullet comment interaction content that have a collision means performing position separation on positions at which the first elements “great” and “B” that have a collision are located.

An implementation of performing position separation on positions corresponding to the first elements between the first bullet comment interaction content and the second bullet comment interaction content that are determined to have a collision may be: changing frame values of a layer corresponding to the first bullet comment interaction content and a layer corresponding to the second bullet comment interaction content that have a collision.

For a layer corresponding to the confrontational effect, the confrontational effect may be presented frame by frame at the same interface refresh rate of the video playback interface, until bullet comment interaction content of a specific camp covers the entire video playback interface.

In some embodiments, when the confrontational effect includes a screen dominance effect, the first bullet comment interaction content and the second bullet comment interaction content are displayed in one or more display tracks, and the first bullet comment interaction content and the second bullet comment interaction content are stored in a queue in each display track, the terminal may present the confrontational effect between the first bullet comment interaction content and the second bullet comment interaction content in the video playback interface in the following manner: emptying the second bullet comment interaction content in the queue of each display track, and removing a layer corresponding to the second bullet comment interaction content; filling, within a preset time period, an empty position in the one or more display tracks with the first bullet comment interaction content, and rendering and displaying the filled first bullet comment interaction content; or emptying the first bullet comment interaction content in the queue of each display track, and removing a layer corresponding to the first bullet comment interaction content; and filling, within a preset time period, an empty position in the one or more display tracks with the second bullet comment interaction content, and rendering and displaying the filled second bullet comment interaction content.

In an actual application, when the confrontational effect includes a screen dominance effect, bullet comment interaction content belonging to different camps is displayed in one or more display tracks, and bullet comment interaction content of different camps is stored in a queue in each display track. When a confrontational effect is presented between bullet comment interaction content belonging to different camps in the video playback interface, the second bullet comment interaction content in the queue of each display track may be emptied, and the layer corresponding to the second bullet comment interaction content is removed. Within a preset time period (that is, a time period t1), an empty position on the one or more display tracks is filled with the first bullet comment interaction content corresponding to the first camp, and the filled first bullet comment interaction content is rendered and displayed; or the first bullet comment interaction content is emptied in the queue of each display track, and a layer corresponding to the first bullet comment interaction content is removed. Within a preset time period (that is, a time period t1), an empty position in the one or more display tracks is filled with the second bullet comment interaction content corresponding to the second camp, and the filled second bullet comment interaction content is rendered and displayed.

The foregoing display in a confrontational manner may be flexibly selected for use, or may be used in a combination. For example, the foregoing manners 1) and 2) are combined. For example, bullet comment interaction content belonging to different camps is displayed in the same display track of the video playback interface. For example, FIG. 6d is a schematic diagram of performing confrontational display on bullet comment interaction content belonging to different camps according to an embodiment of the present disclosure. In FIG. 6d, bullet comment interaction content 1 and bullet comment interaction content 2 of a camp A are displayed in a movement manner from left to right in a display track 63 of a video playback interface 604, and bullet comment interaction content 3 of a camp B is displayed in a movement manner from right to left in the display track 63 of the video playback interface 604. Further, the foregoing manners 3) and 4) are combined. For example, bullet comment interaction content belonging to different camps is displayed with movement toward each other, and when the bullet comment interaction content belonging to different camps is moved to the same display position of the video playback interface, a confrontational effect is presented between the bullet comment interaction content belonging to different camps in the video playback interface. For example, FIG. 6e is a schematic diagram of performing confrontational display on bullet comment interaction content belonging to different camps according to another embodiment of the present disclosure. In FIG. 6e, M pieces of first bullet comment interaction content belonging to a first camp in a video playback interface 602 include first bullet comment interaction content “AA” and first bullet comment interaction content “AAA”. P pieces of second bullet comment interaction content belonging to a second camp in the video playback interface include second bullet comment interaction content “BB” and second bullet comment interaction content “BBB”. The first bullet comment interaction content belonging to the first camp and the second bullet comment interaction content belonging to the second camp in the video playback interface are displayed with movement toward each other, and when moved to the same display position of the video playback interface, a lightning effect is presented between the first bullet comment interaction content “AA”, the first bullet comment interaction content “AAA”, the second bullet comment interaction content “BB”, and the second bullet comment interaction content “BBB”.

(3) Bullet comment interaction content belonging to different camps is displayed in a video playback interface by regions. That is, using an example in which confrontation includes a first camp and a second camp, the first bullet comment interaction content and the second bullet comment interaction content are displayed in the video playback interface by regions.

For example, the first bullet comment interaction content belonging to the first camp is displayed in a region 1, and the second bullet comment interaction content belonging to the second camp is displayed in a region 2 in the video playback interface.

(4) Bullet comment interaction content belonging to different camps is displayed in the video playback interface alternately in time periods. That is, using an example in which confrontation includes a first camp and a second camp, the first bullet comment interaction content and the second bullet comment interaction content are displayed in the video playback interface alternately in time periods.

Schematically, in the video playback interface, the first bullet comment interaction content belonging to the first camp may be displayed in a time period corresponding to 9:01 to 9:05, and the second bullet comment interaction content belonging to the second camp may be displayed in a time period corresponding to 9:05 to 9:09.

In some embodiments, an interface refresh rate may be set, a quantity of bullet comment interaction content belonging to different camps is obtained according to the interface refresh rate, and a confrontational effect presented between bullet comment interaction content belonging to different camps is updated according to the quantity of bullet comment interaction content belonging to different camps. The interface refresh rate may be set according to requirements. For example, the interface refresh rate may be set to refresh once every 5 minutes, every 20 minutes, or the like. Schematically, using the first camp and the second camp as an example, before interface refresh is performed, M is equal to P, and a lightning effect is presented between bullet comment interaction content belonging to different camps in the video playback interface. After interface refresh is performed, a difference between updated M and updated P is greater than the quantity difference threshold, and bullet comment interaction content belonging to different camps in the video playback interface is updated from presenting a lightning effect to presenting a covering effect.

For the updating, according to the quantity of bullet comment interaction content belonging to different camps, the confrontational effect presented between the bullet comment interaction content belonging to different camps, references may be made to the foregoing specific implementation process of presenting, based on the quantity relationship between M and P, the confrontational effect between the bullet comment interaction content belonging to different camps in the video playback interface, and details are not described herein again.

In the foregoing manner, when an interaction control is configured for prompting to participate in interaction with content confrontation in target information, camps may be selected to implement content confrontation among different camps, thereby enriching add-on content representation forms. In addition, in an content confrontation process, content confrontation is performed by using different camps, so that a sense of participation and stickiness of an interaction participation object on an add-on content such as an advertisement can be enhanced, an interaction effect and a social effect of the add-on content can be improved, and more vivid, interesting, and personalized content confrontation experience can be brought, thereby bringing more exposure, conversion, and reputation effects to an add-on content provider such as an advertiser. In addition, from a perspective of a content delivery strategy, by analyzing behavior data (for example, the behavior data includes choosing to join a specific camp) generated by the interaction participation object, guidance and suggestions may be provided for a brand launching strategy. From a perspective of a video playback platform, because target information is associated with a video, bullet comment interaction content can be personally presented and interacted according to features such as an interest and a behavior of an interaction participation object. In this way, enjoyment of plot content corresponding to the video can be enhanced.

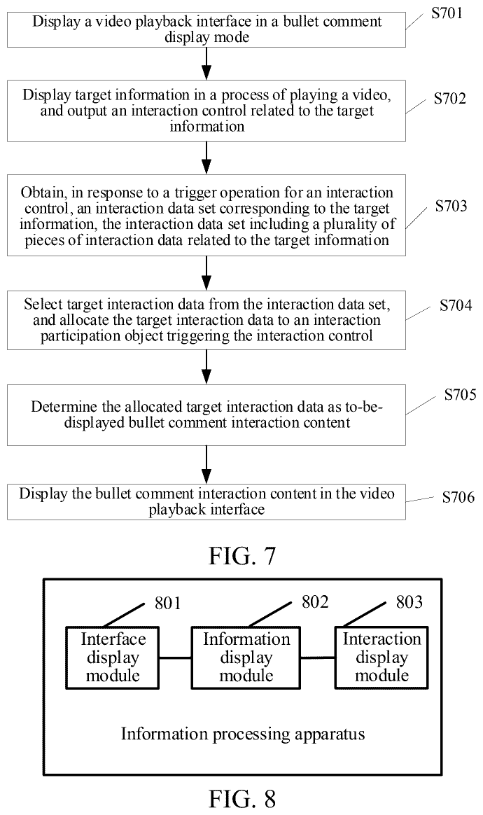

Referring to FIG. 7, FIG. 7 is a schematic flowchart of an information processing method according to another embodiment of the present disclosure. The information processing method may be performed by a terminal, and the information processing method may include the following operation S701 to S706:

S701: Display a video playback interface in a bullet comment display mode.

S702: Display target information in a process of playing a video, and output an interaction control related to the target information.

In some embodiments, the terminal may transmit an placement point request to a server. The placement point request is configured for querying placement point information in the video. After finding the placement point information, the server returns the found placement point information to the terminal. The terminal receives the placement point information returned by the server, where the placement point information includes an placement point, and displays the target information when the video is played to the placement point. The placement point of the target information may be a placement point preconfigured in the video based on a target content add-on requirement; or the placement point is determined by a demand side in a plurality of placement points provisioned in the video. The placement point includes any one of the following: preset scene content in the video and preset playback time of the video.

Before playback time of the video reaches the placement point, the target content request is transmitted to the server, where the target content request carries the placement point, and the target content request is configured for requesting target information at the placement point. After obtaining the target information at the placement point, the server returns the placement point information at the placement point to the terminal. The terminal receives the target information that is at the placement point and that is returned by the server.

After the terminal receives the target information that is at the placement point and that is returned by the server, the terminal may output an interaction control based on the target information, and perform operation S703.

S703: Obtain, in response to a trigger operation for an interaction control, an interaction data set corresponding to the target information, the interaction data set including a plurality of pieces of interaction data related to the target information.

In some embodiments, before obtaining the interaction data set corresponding to the target information, the terminal may collect interaction data in a target collection manner, and storing the collected interaction data into the interaction data set corresponding to the target information, the target collection manner including at least one of the following: obtaining interaction data that is related to the target information and that is preconfigured according to the target information; obtaining, according to time at which the interaction control is triggered, corresponding video comment information in a corresponding playback time period in the video, and using the video comment information as interaction data; and obtaining, according to time at which the interaction control is triggered, corresponding target comment information (e.g., advertisement comment information) within a corresponding display time period of the target information, and using the target comment information as interaction data.

A collection manner (that is, an obtaining manner) of the interaction data in the interaction data set may include at least one of the following: 1). Collect interaction data that is related to the target information and that is preconfigured according to the target information. For example, the target information includes “XX cheer up”, then the preconfigured interaction data related to the target information may be “XX cheer up”, and then the preconfigured “XX cheer up” is obtained as the interaction data. For another example, if the target information includes information about an umbrella, the preconfigured interaction data related to the target information is “this umbrella works well”, and then the preconfigured “this umbrella works well” is obtained as the interaction data. 2). Obtain, according to time at which the interaction control is triggered, corresponding video comment information in a corresponding playback time period in the video, and use the video comment information as interaction data. If the target information is associated with the video, corresponding video comment information (that is, related information for commenting on the video) in a corresponding playback time period of the video may be used as the interaction data. The corresponding playback time period herein refers to: a time period between X seconds before and after time when the interaction control is triggered in the video playing process. A value of X may be set according to a requirement. For example, the value of X may be 1, 3, 4, or the like. For example, the time when the interaction control is triggered is the video being played to the 5^{th} minute, where X=3, and then the video comment information corresponding to the corresponding playback time of the video may be video comment information that is associated with the video and that is transmitted by a commenting object in a time period from the 4^{th} minute 57^{th} second to the 5^{th} minute 03^{rd} second. 3). Obtain, according to time at which the interaction control is triggered, corresponding target comment information within a corresponding display time period of the target information, and use the target comment information as interaction data. The corresponding display time period herein refers to: a time period between Z seconds before and after time when the interaction control is triggered in the video playing process. A value of Z may be set according to a requirement. For example, the value of Z may be 1, 3, 4, or the like. For example, the time when the interaction control is triggered is the video being played to the 6^{th} minute, where Z=3, and then the target comment information corresponding to the corresponding display time of the video may be target comment information that is associated with the target information and that is transmitted by a commenting object in a time period from the 5^{th} minute 57^{th} second to the 6^{th} minute 03^{rd} second.

S704: Select target interaction data from the interaction data set, and allocate the target interaction data to an interaction participation object triggering the interaction control.

There may be one or more pieces of target interaction data. In some embodiments, one or more pieces of interaction data may be randomly selected from the interaction data set as the target interaction data. In some other embodiments, one or more pieces of interaction data whose associations with the target information are greater than an association threshold are selected from the interaction data set as the target interaction data.

A quantity of allocated interaction data may be preconfigured for the interaction participation object. For example, the quantity of interaction data may be 1, 2, 4, or the like. This is not limited in this embodiment of the present disclosure. The selecting one or more pieces of interaction data from the interaction data set may include: selecting interaction data satisfying an interaction data quantity from the interaction data set.

In some embodiments, when the interaction control is configured for prompting to participate in interaction in content confrontation in the target information, content confrontation includes at least a first camp and a second camp, the interaction data set includes a first interaction data set corresponding to the first camp, and a second interaction data set corresponding to the second camp, the terminal may select the target interaction data from the interaction data set in the following manner: determining a camp that the interaction participation object triggering the interaction control chooses to join; and selecting the target interaction data from the first interaction data set when the interaction participation object chooses to join the first camp; or selecting the target interaction data from the second interaction data set when the interaction participation object chooses to join the second camp.

In an actual application, the interaction control may include at least a first camp option (corresponding to the first camp) and a second camp option (corresponding to the second camp), and that the interaction control is triggered may include that the first camp option is triggered or the second camp option is triggered. When the first camp option is triggered, an interaction participation object triggering the first camp option chooses to join the first camp. When the second camp option is triggered, an interaction participation object triggering the second camp option chooses to join the second camp.

The first interaction data set and the second interaction data set are the same or different. That the first interaction data set and the second interaction data set are different includes at least one of the following: 1). Content of interaction data in the first interaction data set is different from content of interaction data in the second interaction data set. The content of the interaction data in the first interaction data set is associated with the first camp, the content of the interaction data in the second interaction data set is associated with the second camp, and the first camp and the second camp respectively represent two different camps in the target information. For example, a camp A is “Little A is great”, a camp B is “Little B is great”, the content of the interaction data in the first interaction data set may be related to Little A, and the content of the interaction data in the second interaction data set may be related to Little B.

2). A quantity of interaction data in the first interaction data set is different from a quantity of interaction data in the second interaction data set.

3). A collection manner of the interaction data in the first interaction data set is different from a collection manner of the interaction data in the second interaction data set. For example, the collection manner of the interaction data in the first interaction data set may include: obtaining preconfigured target interaction data associated with target information as the interaction data in the first interaction data set. The collection manner of the interaction data in the second interaction data set includes: obtaining, according to time at which the interaction control is triggered, corresponding video comment information in a corresponding playback time period in the video as the interaction data in the second interaction data set.

4). An allocation manner of the interaction data in the first interaction data set is different from an allocation manner of the interaction data in the second interaction data set.

In some embodiments, a quantity of interaction data that is in the first interaction data set and that is allocated to the interaction participation object in the first camp is different from a quantity of interaction data that is in the second interaction data set and that is allocated to the interaction participation object in the second camp. For example, a quantity of interaction data that is in the first interaction data set and that is allocated to the interaction participation object in the first camp may be 1, and a quantity of interaction data that is in the second interaction data set and that is allocated to the interaction participation object in the second camps may be 2.

In some other embodiments, the interaction data that is in the first interaction data set and that is allocated to the interaction participation object in the first camp supports dynamic adjustment, and the interaction data that is in the second interaction data set and that is allocated to the interaction participation object in the second camp supports a static allocation rule. That the interaction data that is in the first interaction data set and that is allocated to the interaction participation object in the first camp supports dynamic adjustment means that the interaction data that is in the first interaction data set and that is allocated to the interaction participation object in the first camp may be dynamically adjusted according to a quantity of interaction participation objects in the first camp. For example, when the quantity of interaction participation objects in the first camp is 2, two pieces of interaction data in the second interaction data set may be allocated to each interaction participation object in the first camp. When the quantity of interaction participation objects in the first camp is updated from 2 to 4, one piece of interaction data in the second interaction data set may be allocated to each interaction participation object in the first camp. That the interaction data that is in the second interaction data set and that is allocated to the interaction participation object in the second camp supports a static allocation rule means that the interaction data that is in the second interaction data set and that is allocated to the interaction participation object in the second camps does not change with the quantity of interaction participation objects in the second camp.

S705: Determine the allocated target interaction data as to-be-displayed bullet comment interaction content.

S706: Display the bullet comment interaction content in the video playback interface.

By using the foregoing manner, when the video playback interface is in the bullet comment display mode, in the process of playing the video, the target information is displayed, and the interaction control related to the target information is outputted; in response to the trigger operation for the interaction control, the interaction data set corresponding to the target information is obtained, the interaction data set including a plurality of pieces of interaction data related to the target information; the target interaction data is selected from the interaction data set, and the selected target interaction data is allocated to an interaction participation object triggering the interaction control; the allocated interaction data is determined as the to-be-displayed bullet comment interaction content; and the bullet comment interaction content is displayed in the video playback interface. In this way, an interaction control related to target information is set, and interaction with the target information can be implemented by triggering the interaction control. In this way, an add-on content interaction form is expanded. In addition, the bullet comment interaction content triggered and presented by using the interaction control enriches presentation forms of the target information, and implements interaction with the target information, thereby improving interactivity with the target information.

Referring to FIG. 8, FIG. 8 is a schematic structural diagram of an information processing apparatus according to an embodiment of the present disclosure. The information processing apparatus may be a computer program (including program code) in a computing device. For example, the information processing apparatus may be application software in the computing device. The information processing apparatus may be configured to perform some or all operation in the method embodiments shown in FIG. 2 to FIG. 7. Referring to FIG. 8, the information processing apparatus includes the following modules:

an interface display module 801, configured to display a video playback interface in a bullet comment display mode; an information display module 802, configured to: display target information in a process of playing a video, and output an interaction control related to the target information; and an interaction display module 803, configured to display bullet comment interaction content in the video playback interface in response to a trigger operation for the interaction control.

In some embodiments, the information display module 802 is further configured to display the target information when playback time of the video reaches preset playback time; or display the target information when the video is played to preset scene content.

In some embodiments, the information display module 802 is further configured to display the target information in any position region of the video playback interface; or display the target information in a fixed window or a floating window independent of the video playback interface; or display the target information in a sub-interface independent of the video playback interface.

In some embodiments, the information display module 802 is further configured to output the interaction control related to the target information in a target output manner, the target output manner including at least one of the following: outputting the interaction control in a process of displaying the target information; outputting the interaction control at a display position of the target information; outputting the interaction control around the display position of the target information; and triggering output of the interaction control when the target information is selected; the interaction control including one of the following: a text control, an icon control, a voice control, and a key control.

In some embodiments, the interaction control is configured to prompt to participate in interaction with the target information, and the interaction display module 803 is further configured to perform at least one of the following: displaying the bullet comment interaction content in the video playback interface in an arranged manner; displaying the bullet comment interaction content in the video playback interface in a floating manner; dynamically displaying the bullet comment interaction content in the video playback interface; and displaying the bullet comment interaction content in a fixed region of the video playback interface.

In some embodiments, the interaction control is configured to prompt to participate in interaction in content confrontation in the target information, the content confrontation includes at least a first camp and a second camp, and the bullet comment interaction content includes a first bullet comment interaction content belonging to the first camp and a second bullet comment interaction content belonging to the second camp; and the interaction display module 803 is further configured to perform at least one of the following: differently displaying the first bullet comment interaction content and the second bullet comment interaction content in the video playback interface; displaying the first bullet comment interaction content and the second bullet comment interaction content in the video playback interface in a confrontational manner; displaying the first bullet comment interaction content and the second bullet comment interaction content in the video playback interface by regions; and displaying the first bullet comment interaction content and the second bullet comment interaction content in the video playback interface alternately in time periods; the differently displaying including one of the following: display in different colors, display in different brightness, display in different shapes, and display in different sizes.

In some embodiments, the interaction display module 803 is further configured to perform at least one of the following: displaying the first bullet comment interaction content and the second bullet comment interaction content in a same display track of the video playback interface in a movement manner; the video playback interface being provided with one or more display tracks; displaying the first bullet comment interaction content and the second bullet comment interaction content in the video playback interface with movement toward each other; displaying the first bullet comment interaction content and the second bullet comment interaction content in the video playback interface with movement in opposite directions; presenting a confrontational effect between the first bullet comment interaction content and the second bullet comment interaction content in the video playback interface when the first bullet comment interaction content and the second bullet comment interaction content move to a same display position of the video playback interface; and presenting a confrontational effect between the first bullet comment interaction content and the second bullet comment interaction content in the video playback interface based on a quantity relationship between the first bullet comment interaction content and the second bullet comment interaction content.

In some embodiments, the interaction display module 803 is further configured to present a confrontational effect between the first bullet comment interaction content and the second bullet comment interaction content in the video playback interface when a first quantity of the first bullet comment interaction content is the same as a second quantity of the second bullet comment interaction content; or present a confrontational effect between the first bullet comment interaction content and the second bullet comment interaction content in the video playback interface when a difference between a first quantity of the first bullet comment interaction content and a second quantity of the second bullet comment interaction content is greater than a quantity difference threshold; or present a confrontational effect between the first bullet comment interaction content and the second bullet comment interaction content in the video playback interface when a first quantity of the first bullet comment interaction content is greater than a second quantity of the second bullet comment interaction content and the first quantity is greater than a quantity threshold; or present a confrontational effect between the first bullet comment interaction content and the second bullet comment interaction content in the video playback interface when a second quantity of the second bullet comment interaction content is greater than a first quantity of the first bullet comment interaction content and the second quantity is greater than a quantity threshold; the confrontational effect including any one of the following: an offsetting effect, a covering effect, a lightning effect, a wind and snow effect, a tearing effect, an explosion effect, and a screen dominance effect.

In some embodiments, the confrontational effect includes a covering effect or a screen dominance effect, and the interaction display module 803 is further configured to adjust opacities of layers on which all or some of the second bullet comment interaction content in the video playback interface is located from a first value to a second value when the first quantity of the first bullet comment interaction content is greater than the second quantity of the second bullet comment interaction content and the first quantity is greater than the quantity threshold; and remove all or some of adjusted second bullet comment interaction content from a display track, and display the first bullet comment interaction content in the display track.

In some embodiments, the interaction display module 803 is further configured to determine that first bullet comment interaction content and second bullet comment interaction content that have a collision exist in the video playback interface; perform position separation on the first bullet comment interaction content and the second bullet comment interaction content that have a collision, and add a layer corresponding to a confrontational effect at a separated position; and render the layer corresponding to the confrontational effect, to present the confrontational effect.

In some embodiments, the confrontational effect includes the screen dominance effect, the first bullet comment interaction content and the second bullet comment interaction content are displayed in one or more display tracks, and the first bullet comment interaction content and the second bullet comment interaction content are stored in each display track in a queue; and the interaction display module 803 is further configured to empty the second bullet comment interaction content in the queue of each display track, and remove a layer corresponding to the second bullet comment interaction content; fill, within a preset time period, an empty position in the one or more display tracks with the first bullet comment interaction content, and render and display the filled first bullet comment interaction content; or empty the first bullet comment interaction content in the queue of each display track, and remove a layer corresponding to the first bullet comment interaction content; and fill, within a preset time period, an empty position in the one or more display tracks with the second bullet comment interaction content, and render and display the filled second bullet comment interaction content.

In some embodiments, before the displaying bullet comment interaction content in the video playback interface, the apparatus further includes: an interaction content obtaining module, configured to obtain an interaction data set corresponding to the target information, the interaction data set including a plurality of pieces of interaction data related to the target information; select target interaction data from the interaction data set, and allocate the target interaction data to an interaction participation object triggering the interaction control; and determine the allocated target interaction data as to-be-displayed bullet comment interaction content.

In some embodiments, the interaction content obtaining module is further configured to: collect interaction data in a target collection manner, and store the collected interaction data into the interaction data set corresponding to the target information, the target collection manner including at least one of the following: obtaining interaction data that is related to the target information and that is preconfigured according to the target information; obtaining, according to time at which the interaction control is triggered, corresponding video comment information in a corresponding playback time period in the video, and using the video comment information as interaction data; and obtaining, according to time at which the interaction control is triggered, corresponding target comment information within a corresponding display time period of the target information, and using the target comment information as interaction data.

In some embodiments, the interaction control is configured to prompt to participate in interaction in content confrontation in the target information, and the content confrontation includes at least a first camp and a second camp; the interaction data set includes a first interaction data set corresponding to the first camp, and a second interaction data set corresponding to the second camp; and the interaction content obtaining module is further configured to determine a camp that the interaction participation object triggering the interaction control chooses to join; and select the target interaction data from the first interaction data set when the interaction participation object chooses to join the first camp; or select the target interaction data from the second interaction data set when the interaction participation object chooses to join the second camp; the first interaction data set and the second interaction data set being the same or different, and the first interaction data set and the second interaction data set being different including at least one of the following: content of interaction data in the first interaction data set is different from content of interaction data in the second interaction data set, a quantity of the interaction data in the first interaction data set is different from a quantity of the interaction data in the second interaction data set, a collection manner of the interaction data in the first interaction data set is different from a collection manner of the interaction data in the second interaction data set, and an allocation manner of the interaction data in the first interaction data set is different from an allocation manner of the interaction data in the second interaction data set.

In some embodiments, the information display module 802 is further configured to transmit an placement point request to a server, the placement point request being configured for querying placement point information in the video and returning found placement point information; receive the placement point information returned by the server, the placement point information including an placement point; and display the target information when the video is played to the placement point; the placement point of the target information being a placement point preconfigured in the video based on a target content add-on requirement; or the placement point being determined by a demand side in a plurality of placements provisioned in the video; and the placement point including any one of the following: preset scene content in the video and preset playback time of the video.

In some embodiments, the information obtaining module is further configured to transmit an target content request to the server before the playback time of the video reaches the placement point, the target content request carrying the placement point, and the target content request being configured for requesting target information at the placement point; and receive target information that is at the placement point and that is returned by the server.

The following describes a computing device provided in an embodiment of the present disclosure.

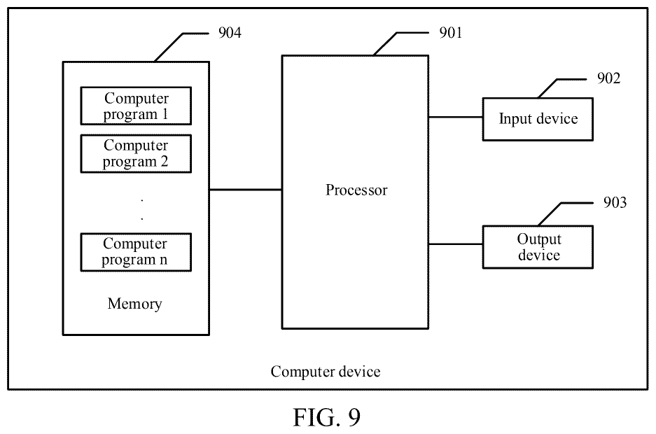

An embodiment of the present disclosure further provides a schematic structural diagram of a computer device. The schematic structural diagram of the computer device is as shown in FIG. 9. The computer device may include: a processor 901, an input device 902, an output device 903, and a memory 904. The processor 901, the input device 902, the output device 903, and the memory 904 are connected by a bus. The memory 904 is configured to store a computer program, the computer program includes program instructions, and the processor 901 is configured to execute the program instructions stored in the memory 904.

In some embodiments, the processor 901 performs the following operations by running the program instructions in the memory 904:

displaying a video playback interface in a bullet comment display mode; displaying target information in a process of playing a video, and outputting an interaction control related to the target information; and displaying bullet comment interaction content in the video playback interface in response to a trigger operation for the interaction control.

In some embodiments, when outputting the interaction control related to the target information, the processor 901 performs the following processing: outputting the interaction control related to the target information in a target output manner, the target output manner including at least one of the following: outputting the interaction control in a process of displaying the target information; outputting the interaction control at a display position of the target information; outputting the interaction control around the display position of the target information; and triggering output of the interaction control when the target information is selected; the interaction control including one of the following: a text control, an icon control, a voice control, and a key control.

In some embodiments, the interaction control is configured to prompt to participate in interaction with the target information. When displaying the bullet comment interaction content in the video playback interface, the processor 901 may specifically perform the following operation: displaying the bullet comment interaction content in the video playback interface in an arranged manner; displaying the bullet comment interaction content in the video playback interface in a floating manner; dynamically displaying the bullet comment interaction content in the video playback interface; and displaying the bullet comment interaction content in a fixed region of the video playback interface.

In some embodiments, the interaction control is configured to prompt to participate in interaction in content confrontation in the target information, and the content confrontation includes at least a first camp and a second camp; the bullet comment interaction content includes first bullet comment interaction content belonging to the first camp and second bullet comment interaction content belonging to the second camp; and when displaying the bullet comment interaction content in the video playback interface, the processor 901 may specifically perform at least one of the following operation: differently displaying the first bullet comment interaction content and the second bullet comment interaction content in the video playback interface; displaying the first bullet comment interaction content and the second bullet comment interaction content in the video playback interface in a confrontational manner; displaying the first bullet comment interaction content and the second bullet comment interaction content in the video playback interface by regions; and displaying the first bullet comment interaction content and the second bullet comment interaction content in the video playback interface alternately in time periods; the differently displaying including one of the following: display in different colors, display in different brightness, display in different shapes, and display in different sizes.

In some embodiments, when displaying the first bullet comment interaction content and the second bullet comment interaction content in the video playback interface in a confrontational manner, the processor 901 may specifically perform at least one of the following operation: displaying the first bullet comment interaction content and the second bullet comment interaction content in a same display track of the video playback interface in a movement manner; the video playback interface being provided with one or more display tracks; displaying the first bullet comment interaction content and the second bullet comment interaction content in the video playback interface with movement toward each other; displaying the first bullet comment interaction content and the second bullet comment interaction content in the video playback interface with movement in opposite directions; presenting a confrontational effect between the first bullet comment interaction content and the second bullet comment interaction content in the video playback interface when the first bullet comment interaction content and the second bullet comment interaction content move to a same display position of the video playback interface; and presenting a confrontational effect between the first bullet comment interaction content and the second bullet comment interaction content in the video playback interface based on a quantity relationship between the first bullet comment interaction content and the second bullet comment interaction content.

In some embodiments, when presenting the confrontational effect between the first bullet comment interaction content and the second bullet comment interaction content in the video playback interface based on the quantity relationship between the first bullet comment interaction content and the second bullet comment interaction content, the processor 901 may specifically perform the following operation: presenting a confrontational effect between the first bullet comment interaction content and the second bullet comment interaction content in the video playback interface when a first quantity of the first bullet comment interaction content is the same as a second quantity of the second bullet comment interaction content; presenting a confrontational effect between the first bullet comment interaction content and the second bullet comment interaction content in the video playback interface when a difference between a first quantity of the first bullet comment interaction content and a second quantity of the second bullet comment interaction content is greater than a quantity difference threshold; or

presenting a confrontational effect between the first bullet comment interaction content and the second bullet comment interaction content in the video playback interface when a first quantity of the first bullet comment interaction content is greater than a second quantity of the second bullet comment interaction content and the first quantity is greater than a quantity threshold; presenting a confrontational effect between the first bullet comment interaction content and the second bullet comment interaction content in the video playback interface when a second quantity of the second bullet comment interaction content is greater than a first quantity of the first bullet comment interaction content and the second quantity is greater than a quantity threshold; the confrontational effect including any one of the following: an offsetting effect, a covering effect, a lightning effect, a wind and snow effect, a tearing effect, an explosion effect, and a screen dominance effect.

In some embodiments, the confrontational effect includes the covering effect or the screen dominance effect. When presenting the confrontational effect between the first bullet comment interaction content and the second bullet comment interaction content in the video playback interface when the first quantity of the first bullet comment interaction content is greater than the second quantity of the second bullet comment interaction content and the first quantity is greater than the quantity threshold, the following operation may be specifically performed: adjusting opacities of layers on which all or some of the second bullet comment interaction content in the video playback interface is located from a first value to a second value when the first quantity of the first bullet comment interaction content is greater than the second quantity of the second bullet comment interaction content and the first quantity is greater than the quantity threshold; and removing all or some of adjusted second bullet comment interaction content from a display track, and displaying the first bullet comment interaction content in the display track.

In some embodiments, when presenting the confrontational effect between the first bullet comment interaction content and the second bullet comment interaction content in the video playback interface, the processor 901 may specifically perform the following operation: determining that first bullet comment interaction content and second bullet comment interaction content that have a collision exist in the video playback interface; performing position separation on the first bullet comment interaction content and the second bullet comment interaction content that have a collision, and adding a layer corresponding to a confrontational effect at a separated position; and rendering the layer corresponding to the confrontational effect, to present the confrontational effect.

In some embodiments, the confrontational effect includes the screen dominance effect, the first bullet comment interaction content and the second bullet comment interaction content are displayed in one or more display tracks, and the first bullet comment interaction content and the second bullet comment interaction content are stored in each display track in a queue; and when presenting the confrontational effect between the first bullet comment interaction content and the second bullet comment interaction content in the video playback interface, the processor 901 may specifically perform the following operation:

emptying the second bullet comment interaction content in the queue of each display track, and removing a layer corresponding to the second bullet comment interaction content;

filling, within a preset time period, an empty position in the one or more display tracks with the first bullet comment interaction content, and rendering and displaying the filled first bullet comment interaction content; or emptying the first bullet comment interaction content in the queue of each display track, and removing a layer corresponding to the first bullet comment interaction content; and filling, within a preset time period, an empty position in the one or more display tracks with the second bullet comment interaction content, and rendering and displaying the filled second bullet comment interaction content.

In some embodiments, before displaying the bullet comment interaction content in the video playback interface, the processor 901 may further perform the following operation: obtaining an interaction data set corresponding to the target information, the interaction data set including a plurality of pieces of interaction data related to the target information; selecting target interaction data from the interaction data set, and allocating the target interaction data to an interaction participation object triggering the interaction control; and determining the allocated target interaction data as to-be-displayed bullet comment interaction content.

In some embodiments, interaction data is collected in a target collection manner, and the collected interaction data is stored into the interaction data set corresponding to the target information, where the target collection manner includes at least one of the following: obtaining interaction data that is related to the target information and that is preconfigured according to the target information; obtaining, according to time at which the interaction control is triggered, corresponding video comment information in a corresponding playback time period in the video, and using the video comment information as interaction data; and obtaining, according to time at which the interaction control is triggered, corresponding target comment information within a corresponding display time period of the target information, and using the target comment information as interaction data.

In some embodiments, the interaction control is configured to prompt to participate in interaction in content confrontation in the target information, and the content confrontation includes at least a first camp and a second camp; the interaction data set includes a first interaction data set corresponding to the first camp, and a second interaction data set corresponding to the second camp; and when selecting the target interaction data from the interaction data set, the processor 901 may specifically perform the following operation: determining a camp that the interaction participation object triggering the interaction control chooses to join; and selecting the target interaction data from the first interaction data set when the interaction participation object chooses to join the first camp; or selecting the target interaction data from the second interaction data set when the interaction participation object chooses to join the second camp. The first interaction data set and the second interaction data set being the same or different, and the first interaction data set and the second interaction data set being different including at least one of the following: content of interaction data in the first interaction data set is different from content of interaction data in the second interaction data set, a quantity of the interaction data in the first interaction data set is different from a quantity of the interaction data in the second interaction data set, a collection manner of the interaction data in the first interaction data set is different from a collection manner of the interaction data in the second interaction data set, and an allocation manner of the interaction data in the first interaction data set is different from an allocation manner of the interaction data in the second interaction data set.

In some embodiments, when displaying the target information in the process of playing the video, the processor 901 may specifically perform the following operation: transmitting an placement point request to a server, the placement point request being configured for querying placement point information in the video and returning found placement point information; receiving the placement point information returned by the server, the placement point information including an placement point; and displaying the target information when the video is played to the placement point. The placement point of the target information may be a placement point preconfigured in the video based on a target content add-on requirement; or the placement point is determined by a demand side in a plurality of placement points provisioned in the video. The placement point includes any one of the following: preset scene content in the video and preset playback time of the video.

In some embodiments, the processor 901 may further perform the following operation: transmitting an target content request to the server before the playback time of the video reaches the placement point, the target content request carrying the placement point, and the target content request being configured for requesting target information at the placement point; and receiving target information that is at the placement point and that is returned by the server.

An embodiment of the present disclosure further provides a computer-readable storage medium, having a computer program stored therein, and the computer program includes program instructions. When the program instructions are executed by a processor, the methods in the embodiments corresponding to FIG. 2 and FIG. 7 can be performed, and descriptions thereof are omitted herein. For technical details that are not disclosed in the embodiments of the computer-readable storage medium included in the present disclosure, reference may be made to the descriptions about the method embodiments of the present disclosure. In an example, the program instructions may be deployed to be executed on one computer device, or deployed to be executed on a plurality of computer devices at the same position, or deployed to be executed on a plurality of computer devices that are distributed in a plurality of positions and interconnected by using a communication network.

According to an aspect of the present disclosure, a computer program product is provided, where the computer program product includes a computer program, and the computer program is stored in a computer-readable storage medium. A processor of a computer device reads the computer program from the computer-readable storage medium, and the processor executes the computer program to enable the computer device to perform the methods in the embodiments corresponding to FIG. 2 and FIG. 7, and descriptions thereof are omitted herein.

A person of ordinary skill in the art is to understand that all or a part of the processes of the method in the foregoing embodiment may be implemented by a program instructing relevant hardware. The program may be stored in a computer readable storage medium. When the program is run, the processes of the method in the foregoing embodiment are performed. The foregoing storage medium may include a magnetic disc, an optical disc, a read-only memory (ROM), a random access memory (RAM), or the like.

What is disclosed above is merely exemplary embodiments of the present disclosure, and certainly is not intended to limit the scope of the claims of the present disclosure. Therefore, equivalent variations made in accordance with the claims of the present disclosure shall fall within the scope of the present disclosure.

What is claimed is:

1. An information processing method, performed by a computer device and comprising:
displaying a video playback interface in a bullet comment display mode;
displaying target information in a process of playing a video, and outputting an interaction control related to the target information; and
displaying bullet comment interaction content in the video playback interface in response to a trigger operation for the interaction control.

2. The method according to claim 1, wherein the displaying target information in a process of playing a video comprises:
displaying the target information when playback time of the video reaches preset playback time; or
displaying the target information when the video is played to preset scene content.

3. The method according to claim 1, wherein the displaying target information comprises:
displaying the target information in a position region of the video playback interface; or
displaying the target information in a fixed window or a floating window independent of the video playback interface; or
displaying the target information in a sub-interface independent of the video playback interface.

4. The method according to claim 1, wherein the outputting an interaction control related to the target information comprises:
outputting the interaction control related to the target information in a target output manner, the target output manner comprising at least one of the following:
outputting the interaction control in a process of displaying the target information;
outputting the interaction control at a display position of the target information;
outputting the interaction control around the display position of the target information; and
triggering output of the interaction control when the target information is selected;
the interaction control comprising one of the following: a text control, an icon control, a voice control, and a key control.

5. The method according to claim 1, wherein the interaction control is configured to prompt to participate in interaction with the target information, and the displaying bullet comment interaction content in the video playback interface comprises at least one of the following:
displaying the bullet comment interaction content in the video playback interface in an arranged manner;
displaying the bullet comment interaction content in the video playback interface in a floating manner;
dynamically displaying the bullet comment interaction content in the video playback interface; and
displaying the bullet comment interaction content in a fixed region of the video playback interface.

6. The method according to claim 1, wherein the interaction control is configured to prompt to participate in interaction in content confrontation in the target information, the content confrontation comprises at least a first camp and a second camp, and the bullet comment interaction content comprises a first bullet comment interaction content belonging to the first camp and a second bullet comment interaction content belonging to the second camp.

7. The method according to claim 6, wherein the displaying bullet comment interaction content in the video playback interface comprises:
differently displaying the first bullet comment interaction content and the second bullet comment interaction content in the video playback interface;
the differently displaying comprising one of the following: display in different colors, display in different brightness, display in different shapes, or display in different sizes.

8. The method according to claim 6, wherein the displaying bullet comment interaction content in the video playback interface further comprises at least one of:
displaying the first bullet comment interaction content and the second bullet comment interaction content in the video playback interface by regions; or
displaying the first bullet comment interaction content and the second bullet comment interaction content in the video playback interface alternately in time periods.

9. The method according to claim 6, wherein the bullet comment interaction content in the video playback interface is displayed in a confrontational manner, and the confrontation manner comprises at least one of:
displaying the first bullet comment interaction content and the second bullet comment interaction content in a same display track of the video playback interface in a movement manner; the video playback interface being provided with one or more display tracks;
displaying the first bullet comment interaction content and the second bullet comment interaction content in the video playback interface with movement toward each other;
displaying the first bullet comment interaction content and the second bullet comment interaction content in the video playback interface with movement in opposite directions;
presenting a confrontational effect between the first bullet comment interaction content and the second bullet comment interaction content in the video playback interface when the first bullet comment interaction content and the second bullet comment interaction content move to a same display position of the video playback interface; or
presenting a confrontational effect between the first bullet comment interaction content and the second bullet comment interaction content in the video playback interface based on a quantity relationship between the first bullet comment interaction content and the second bullet comment interaction content.

10. The method according to claim 9, wherein the presenting a confrontational effect between the first bullet comment interaction content and the second bullet comment interaction content in the video playback interface based on a quantity relationship between the first bullet comment interaction content and the second bullet comment interaction content comprises:
presenting a confrontational effect between the first bullet comment interaction content and the second bullet comment interaction content in the video playback interface when a first quantity of the first bullet comment interaction content is the same as a second quantity of the second bullet comment interaction content; or
presenting a confrontational effect between the first bullet comment interaction content and the second bullet comment interaction content in the video playback interface when a difference between a first quantity of the first bullet comment interaction content and a second quantity of the second bullet comment interaction content is greater than a quantity difference threshold; or
presenting a confrontational effect between the first bullet comment interaction content and the second bullet comment interaction content in the video playback interface when a first quantity of the first bullet comment interaction content is greater than a second quantity of the second bullet comment interaction content and the first quantity is greater than a quantity threshold; or
presenting a confrontational effect between the first bullet comment interaction content and the second bullet comment interaction content in the video playback interface when a second quantity of the second bullet comment interaction content is greater than a first quantity of the first bullet comment interaction content and the second quantity is greater than a quantity threshold;
the confrontational effect comprising any one of the following: an offsetting effect, a covering effect, a lightning effect, a wind and snow effect, a tearing effect, an explosion effect, and a screen dominance effect.

11. The method according to claim 10, wherein the confrontational effect comprises the covering effect or the screen dominance effect; and the presenting a confrontational effect between the first bullet comment interaction content and the second bullet comment interaction content in the video playback interface when a first quantity of the first bullet comment interaction content is greater than a second quantity of the second bullet comment interaction content and the first quantity is greater than a quantity threshold comprises:
adjusting opacities of layers on which all or some of the second bullet comment interaction content in the video playback interface is located from a first value to a second value when the first quantity of the first bullet comment interaction content is greater than the second quantity of the second bullet comment interaction content and the first quantity is greater than the quantity threshold; and
removing all or some of adjusted second bullet comment interaction content from a display track, and displaying the first bullet comment interaction content in the display track.

12. The method according to claim 9, wherein the presenting a confrontational effect between the first bullet comment interaction content and the second bullet comment interaction content in the video playback interface comprises:
determining that first bullet comment interaction content and second bullet comment interaction content that have a collision exist in the video playback interface;
performing position separation on the first bullet comment interaction content and the second bullet comment interaction content that have a collision, and adding a layer corresponding to a confrontational effect at a separated position; and
rendering the layer corresponding to the confrontational effect, to present the confrontational effect.

13. The method according to claim 9, wherein the confrontational effect comprises the screen dominance effect, the first bullet comment interaction content and the second bullet comment interaction content are displayed in one or more display tracks, and the first bullet comment interaction content and the second bullet comment interaction content are stored in each display track in a queue; and the presenting a confrontational effect between the first bullet comment interaction content and the second bullet comment interaction content in the video playback interface comprises:
emptying the second bullet comment interaction content in the queue of each display track, and removing a layer corresponding to the second bullet comment interaction content;
filling, within a preset time period, an empty position in the one or more display tracks with the first bullet comment interaction content, and rendering and displaying the filled first bullet comment interaction content; or
emptying the first bullet comment interaction content in the queue of each display track, and removing a layer corresponding to the first bullet comment interaction content; and
filling, within a preset time period, an empty position in the one or more display tracks with the second bullet comment interaction content, and rendering and displaying the filled second bullet comment interaction content.

14. The method according to claim 1, further comprising:
obtaining an interaction data set corresponding to the target information, the interaction data set comprising a plurality of pieces of interaction data related to the target information;
selecting target interaction data from the interaction data set, and allocating the target interaction data to an interaction participation object triggering the interaction control; and
determining the allocated target interaction data as bullet comment interaction content to be displayed.

15. The method according to claim 14, further comprising:
collecting interaction data in a target collection manner, and storing the collected interaction data into the interaction data set corresponding to the target information, the target collection manner comprising at least one of the following:
obtaining interaction data that is related to the target information and that is preconfigured according to the target information;
obtaining, according to time at which the interaction control is triggered, corresponding video comment information in a corresponding playback time period in the video, and using the video comment information as interaction data; and
obtaining, according to time at which the interaction control is triggered, corresponding target comment information within a corresponding display time period of the target information, and using the target comment information as interaction data.

16. The method according to claim 14, wherein the interaction control is configured to prompt to participate in interaction in content confrontation in the target information, and the content confrontation comprises at least a first camp and a second camp; the interaction data set comprises a first interaction data set corresponding to the first camp, and a second interaction data set corresponding to the second camp; and the selecting target interaction data from the interaction data set comprises:
determining a camp that the interaction participation object triggering the interaction control chooses to join; and
selecting the target interaction data from the first interaction data set when the interaction participation object chooses to join the first camp; or
selecting the target interaction data from the second interaction data set when the interaction participation object chooses to join the second camp;
the first interaction data set and the second interaction data set being the same or different, and the first interaction data set and the second interaction data set being different comprising at least one of the following: content of interaction data in the first interaction data set is different from content of interaction data in the second interaction data set, a quantity of the interaction data in the first interaction data set is different from a quantity of the interaction data in the second interaction data set, a collection manner of the interaction data in the first interaction data set is different from a collection manner of the interaction data in the second interaction data set, and an allocation manner of the interaction data in the first interaction data set is different from an allocation manner of the interaction data in the second interaction data set.

17. The method according to claim 1, wherein the displaying target information in a process of playing a video comprises:
transmitting an placement point request to a server, the placement point request being configured for querying placement point information in the video and returning found placement point information;
receiving the placement point information returned by the server, the placement point information comprising an placement point; and
displaying the target information when the video is played to the placement point;
the placement point of the target information being a placement point preconfigured in the video based on a target requirement; or the placement point being determined by a demand side in a plurality of placement points provisioned in the video; and the placement point comprising any one of the following: preset scene content in the video and preset playback time of the video.

18. The method according to claim 17, further comprising:
transmitting an target content request to the server before the playback time of the video reaches the placement point, the target content request carrying the placement point, and the target content request being configured for requesting target information at the placement point; and
receiving target information that is at the placement point and that is returned by the server.

19. An information processing apparatus, comprising:
a processor, adapted to execute a computer program; and
a non-transitory computer-readable storage medium, the computer-readable storage medium storing the computer program, and when the computer program is executed by the processor, the processor is configured to perform:
displaying a video playback interface in a bullet comment display mode;
displaying target information in a process of playing a video, and outputting an interaction control related to the target information; and
displaying bullet comment interaction content in the video playback interface in response to a trigger operation for the interaction control.

20. A non-transitory computer-readable storage medium, the computer-readable storage medium having a computer program stored therein, the computer program, when executed by a processor, causing the processor to perform:
displaying a video playback interface in a bullet comment display mode;
displaying target information in a process of playing a video, and outputting an interaction control related to the target information; and
displaying bullet comment interaction content in the video playback interface in response to a trigger operation for the interaction control.
